(19) United States
(12) Patent Application Publication
(10) Pub. No.: US 2017/0011325 A1
(43) Pub. Date: Jan. 12, 2017

(54) Provisioning An Integrated Recruiting, Training and Financing Service Via A Network

(71) Applicant: Job Market Maker, LLC, Charleston, SC (US)

(72) Inventors: Joseph W. Hanna, Charleston, SC (US); Aleksandar Pekec, Chapel Hill, NC (US)

(73) Assignee: Job Market Maker, LLC, Charleston, SC (US)

(21) Appl. No.: 15/119,535

(22) PCT Filed: Feb. 18, 2015
(86) PCT No.: PCT/US15/16256

§ 371 Date: Aug. 17, 2016

Related U.S. Application Data
(60) Provisional application No. 61/940,972, filed on Feb. 18, 2014.

(51) Int. Cl. G06Q 10/06; G06Q 10/10

(52) U.S. Cl. CPC G06Q 10/063112; G06Q 10/1053

(57) ABSTRACT

A system to receive an instruction to match candidates to a job announcement; identify first qualifications, of each candidate, that match parameters of the job; identify a second qualification, for any candidate, that does not match any of the parameters; determine a cost to provide a service to enable any candidate to obtain the second qualification; determine a score for each candidate based on the first qualifications, the second qualification, or the cost to provide the service; select a candidate based on the score for each candidate; obtain credit information that identifies terms of financing that can be extended; and output an indication that identifies at least one of the first qualifications of the selected candidate, the second qualification of the selected candidate, the score for the selected candidate, the cost to provide the service, or the credit information to cover the cost of the service.

### BACKGROUND

Computing and communication devices are capable of performing an increasing variety of functions and tasks that continue to improve the user's experience. For example, computing and communication devices can run a variety of applications, can connect to a variety of wired and wireless networks to receive services, can access a variety of services and/or perform various functions associated with ecommerce, point of sale transactions, social networking, downloading and uploading content, sending and receiving messages, etc.

Recruiting websites, services, or applications usually permit an employer, associated with a user device, to post job openings (e.g., via a website, listserv, a Rich Site Summary (RSS) feed, etc.) that can be accessed by a candidate, associated with a different user device, that is seeking a job. The recruiting websites, services, or applications may enable the candidate to respond to the job opening (e.g., usually by uploading a resume and/or cover letter, completing a form, etc.) that is then provided to the employer. The employer may review the response received from the candidate and may communicate with the candidate to arrange an interview to determine whether to provide an offer to the candidate. Unfortunately, the recruiting websites, services, or applications usually do not determine how closely the candidate credentials match the job opening and/or identify a gap between a candidate credential and a specific job requirement. Furthermore, the recruiting websites, services, or applications may not identify particular training, an educational institution to provide the particular training, or any costs charged by the educational institution for the particular training that would be taken by the candidate to satisfy the specific job requirement to close the gap.

### SUMMARY

According to one implementation, described herein, a server device may include one or more processors executing one or more instructions to: receive, by the server device, an instruction to match candidates to a job announcement. The job announcement may identify job parameters associated with a job. The one or more processors may also identify, based on the instruction, one or more first qualifications, for each of one or more candidates, that match at least one of the job parameters; identify, based on the one or more first qualifications, one or more second qualifications, for each of the one or more candidates, that do not match any of the job parameters; and determine, based on the identified one or more second qualifications, a cost, associated with each of the one or more candidates, for a service provider to provide one or more services to enable each of the one or more candidates to obtain the one or more second qualifications. The one or more processors may further determine, based on determining the cost, a score for each of the one or more candidates based on the one or more first qualifications, the one or more second qualifications, or the cost to provide the one or more services; select, based on the score for each of the one or more candidates, a candidate, of the one or more candidates, based on the score for each of the one or more candidates; and obtain, based on the selected candidate, credit information that identifies terms of financing that can be extended, by a credit provider, to cover the cost to provide the one or more services to the selected candidate. The one or more processors may also output, based on obtaining the credit information, an indication that identifies at least one of the one or more first qualifications of the selected candidate, the one or more second qualifications of the selected candidate, the score for the selected candidate, the cost to provide the one or more services to the selected candidate, or the credit information.

According to another implementation, described herein, a method, performed by a server device executing one or more instructions, may include receiving, by the server device, an instruction to match candidates to a job announcement. The job announcement may identify job parameters associated with a job. The method may also include identifying, by the server device and based on the instruction, a first candidate, of the candidates, and a second candidate, of the candidates, with one or more first qualifications and one or more second qualifications, respectively, that most closely match the job parameters relative to other qualifications associated with another one or more of the candidates; identifying, by the server device and based on identifying the first candidate and the second candidate, a third qualification, of the first candidate, that does not match any of the job parameters and a fourth qualification, of the second candidate, that does not match any of the job parameters; and determining, by the server device, a first cost of a first service and a second cost of a second service. The first service may enable the first candidate to obtain the third qualification, and the second service may enable the second candidate to obtain the fourth qualification. The method may further include determining, by the server device, a first score for the first candidate and a second score, for the second candidate, the first score being based on the one or more first qualifications, the third qualification and the first cost, and the second score being based on the one or more second qualifications, the fourth qualification and the second cost; and outputting, by the server device and to a different server device associated with an employer that placed the job announcement, a first proposal associated with the first candidate and a second proposal associated with the second candidate. The first proposal may identify at least one of the first score, the first cost, the one or more first qualifications and the third qualification; and the second proposal may identify at least one of the second score, the second cost, the one or more second qualifications and the fourth qualification. The method may still further include receiving, by the server device and from the different server device, selection of the first proposal; obtaining, by the server device and based on receiving the selection of the first proposal, credit information that identifies terms of financing that could be extended, by a credit provider, to the first candidate or the employer to cover the first cost; and outputting, by the server device and to the different server device, the credit information.

According to a further implementation, a system may include one or more server devices, executing one or more instructions, to receive an instruction to identify a candidate that is most closely qualified for a job announcement. The job announcement may identify parameters associated with a job. The one or more servers may also compare, based on the instruction, the parameters to qualifications associated with a group of candidates; compute, based on comparing the parameters to the qualifications, a score for each candidate, of the group of candidates. The score may be based on any matches between the qualifications, of the each candidate, and any of the parameters. The one or more server devices may further identify, based on computing the score, a qualification gap for the each candidate. The qualification gap may be identified when any qualification, of the each candidate, does not match any of the parameters. The one or more server devices may still further obtain, for the each candidate, service information that identifies one or more services that, if provided, can eliminate the qualification gap for the each candidate. The service information may identify a cost for the one or more services. The one or more server device may yet further modify, based on obtaining the service information, the score for the each candidate, based on a respective cost to provide the one or more services, to each candidate, to eliminate the qualification gap; select a candidate, of the group of candidates, based on a modified score, associated with the selected candidate, relative to the modified score for the each candidate; and output information that identifies the modified score associated with the selected candidate, any matches between the qualifications of the selected candidate and any of the parameters, a qualification gap of the selected candidate and the respective cost to provide the one or more services to eliminate the qualification gap of the selected candidate.

### BRIEF DESCRIPTION OF THE DRAWINGS

FIG. 1 is a diagram of an example environment in which systems and/or methods described herein may be implemented;

FIG. 2 is a diagram of example components of one or more of the devices of FIG. 1;

FIG. 3 is a diagram of an example framework that may be associated with an application being hosted and/or executed by an application server of FIG. 1;

FIG. 4 is a flow chart of an example process that may be used to register one or more devices of FIG. 1 according to an implementation described herein;

FIG. 5 is a flow chart of an example process that may be used to create a job announcement according to an implementation described herein;

FIGS. 6A and 6B are diagrams of example user interfaces that may enable a job announcement to be created and/or made available to a candidate;

FIG. 7 is a flow chart of an example process that may be used to by a candidate to register and/or to create candidate information according to an implementation described herein;

FIG. 8A is a flow chart of an example process to match a candidate with a job announcement according to an implementation described herein;

FIG. 8B is a diagram of an example data structure that may be used to match a candidate with a job announcement according to an implementation described herein;

FIGS. 9A and 9B are example user interfaces that may identify one or more candidates that are matched to a job announcement;

FIG. 10 is a flow chart of an example process that may be used to provision a credit service to an employer and/or candidate in connection with a job announcement according to an implementation described herein; and

FIG. 11 is a diagram of example user interface that identifies a proposed plan of to enable a candidate to become completely compliant with a job announcement.

### DETAILED DESCRIPTION OF PREFERRED EMBODIMENTS

The following detailed description refers to the accompanying drawings. The same reference numbers in different drawings may identify the same or similar elements.

The systems, methods, technologies, and/or techniques (hereinafter referred to as the “systems and/or methods”), described herein, may enable a server device (hereinafter, an “application server”) to provision services associated with recruiting, processing and creating a job announcement, scoring and/or matching a candidate to a job announcement, identifying a gap in a candidate's credentials relative to such job announcement, availing services to reduce or eliminate such a gap, and provisioning financial resources to pay for such services. In one example, the application server may execute an application (e.g., logic in the form of software, hardware, or a combination of software and hardware) that enables the application server to perform the systems and/or methods described herein (hereinafter, referred to as “recruiting application”). The systems and/or methods may enable the application server to use the recruiting application to reduce and/or eliminate barriers to matching an otherwise qualified candidate to a job announcement to speed the hiring process. Reducing and/or eliminating such barriers may, for example, expedite the recruiting timeline, reduce the administrative and lost-productivity costs of recruiting, identify a broader range of potentially qualified candidates for a job, and/or provide liquidity to facilitate or accelerate the hiring of a candidate.

The systems and/or methods may enable user devices and/or server devices, associated with candidates and employers, as well as recruiters, educational institutions, financial institutions, and/or other service providers to access the application server to register, access recruiting services and/or to provide information. For example, the systems and/or methods may enable a server, with which an employer is associated, to register with the application server to enable the employer to access services provided by the application server. The employer server may, for example, set up an employer profile for identity, authentication and billing, as well as to permit access to a portal via which information, associated with a job announcement, may be entered and/or information regarding potential candidates can be viewed or selected.

The systems and/or methods may also, or alternatively, enable a user device, with which a candidate is associated, to register with the system to enable the candidate to access services provided by the application server. The candidate may set up a candidate profile for identity, authentication and billing, as well as to access the application server to upload information associated with the candidate and/or view a job announcement.

The systems and/or methods may enable the application server to create a job announcement based on information associated with the job announcement received from an employer server and/or information associated with functions, success factors, desired levels of proficiency in such functions or success factors, and/or other parameters associated with a type of job on which the job announcement is based. The application server may also, or alternatively, compare information received from a candidate user device to processed information associated with a job announcement to determine a degree to which a candidate matches a job announcement. Additionally, or alternatively, such candidate matching may include identifying a gap between the candidate and the job announcement based on a portion of the information, associated with the candidate, that does not match the information associated with the job announcement. Such a gap may correspond to a lack of a certain credential or certification, education level, license, etc. Additionally, or alternatively, a gap may correspond to a geographic distance between the employer and candidate that may require relocation services and/or costs associated therewith. The systems and/or methods may enable the application server to create a match score that represents a degree of match between a candidate and a job announcement relative to other candidates, any gaps associated therewith, a cost to close such gap (e.g., associated with costs of a service provider), a time period need to close a gap (e.g., based on a time to relocate, to complete a certification class, etc.), etc.

The systems and/or methods may also, or alternatively, enable a server, with which a service provider is associated, to register with the application server for identity, authentication and billing, as well as to enable the service provider to access services and/or provide information associated with the service provider and services offered by such provider. A service provider may, for example, be an educational institution, a college, a university, a technical college, a vocational training entity, a certification center, a licensing center, a testing center, a relocation and moving provider, a temporary housing provider, etc. The service provider server may, for example, access the application server to enter service provider information associated with the service provider and/or to bid on requirements to enable candidates to close gaps associated with job openings (e.g., gaps between candidate credentials and experience and parameters of job opening, such as in skills, certifications, education, licenses, location, etc.).

The systems and/or methods may enable a server, with which a credit provider is associated, to register with the application server for identity, authentication and billing, as well as to enable the credit provider to access services and/or provide information associated with the credit provider and financial services offered by such credit provider. Credit providers may, for example, include a bank, a credit union, a federal or state agency, an investment group, and/or a person that is capable of extending credit, funds, or financial resources or advice to a candidate, employer, or the application server. The credit provider server may, for example, access the application server to use a service, enter information associated with the credit provider and/or to bid on financing requirements to enable candidates to close gaps associated with job openings.

The systems and/or methods may generate a respective proposal associated with top ranked candidates (e.g., based on the above-identified scores) and may provide information associated with such proposal to the employer server. The proposal may include information associated with a candidate, a service (e.g., relocation, training, etc.), pre-approved credit (e.g., to finance the service), for each gap associated with the candidate that are to be closed to bring the candidate into compliance with the job announcement. The proposal may also, or alternatively, identify the total cost of acquisition of one or more candidates based on salary requirements, relocation expenses (if any), educational expenses (if any) and/or other costs for services provided to a candidate during or after the recruiting process. Some or all of the information, associated with the proposal, may be de-identified and/or anonymized to prevent disclosure of the candidate, service provider and/or creditor personal and/or confidential information. Employee and/or educational institution consent may be obtained prior to providing the proposal to the employer. Once received, the employer server may provide, to application server, a notification indicating whether the proposal is approved, rejected, or to be modified.

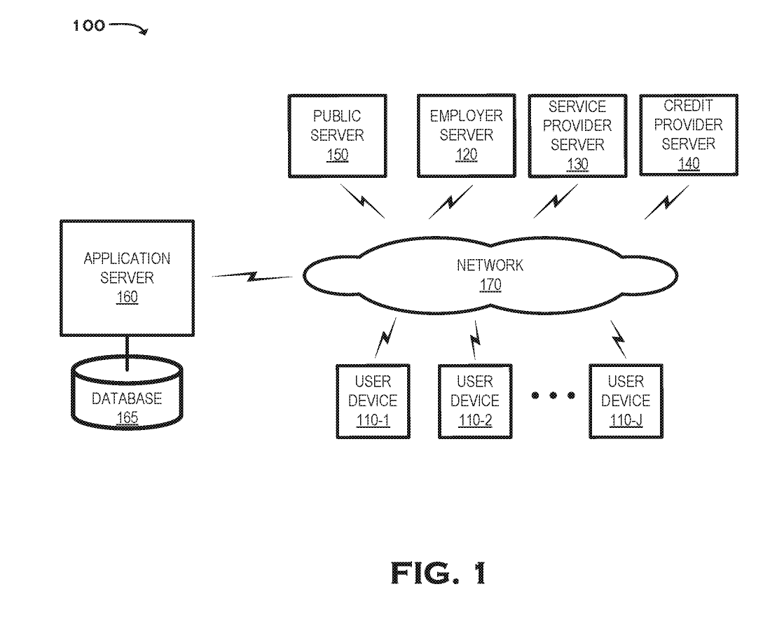

FIG. 1 is a diagram of an example environment 100 in which systems and/or methods described herein may be implemented. As shown in FIG. 1, environment 100 may include a group of user devices 110-1, . . . , 1104 (where J≧1) (hereafter referred to collectively as “user devices 110” and each, a “user device 110”), an employer server 120, a service provider server 130, a credit provider server 140, a public server 150, an application server 160, a database 165 and a network 170. The number of devices and/or networks, illustrated in FIG. 1, is provided for explanatory purposes only. In practice, there may be additional devices and/or networks; fewer devices and/or networks; different devices and/or networks; or differently arranged devices and/or networks than illustrated in FIG. 1.

Also, in some implementations, one or more of the devices of environment 100 may perform one or more functions described as being performed by another one or more of the devices of environment 100. Devices of environment 100 may interconnect via wired connections, wireless connections, or a combination of wired and wireless connections.

User device 110 may include any computation or communication device, such as a wireless mobile communication device that is capable of communicating with a network (e.g., network 170). For example, user device 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a laptop computer, a tablet computer, a camera, a personal gaming system, or another type of mobile computation or communication device that is capable of sending traffic to and/or receiving traffic from application server 160 via network 170. Additionally, or alternatively, user device 110 may include a desktop computer, a set top box, and/or other communication or communication device that is capable of communicating with network 170. In one example implementation, user device 110 may include a global positioning satellite (GPS) component that communicates with a GPS constellation to obtain location information associated with user device 110.

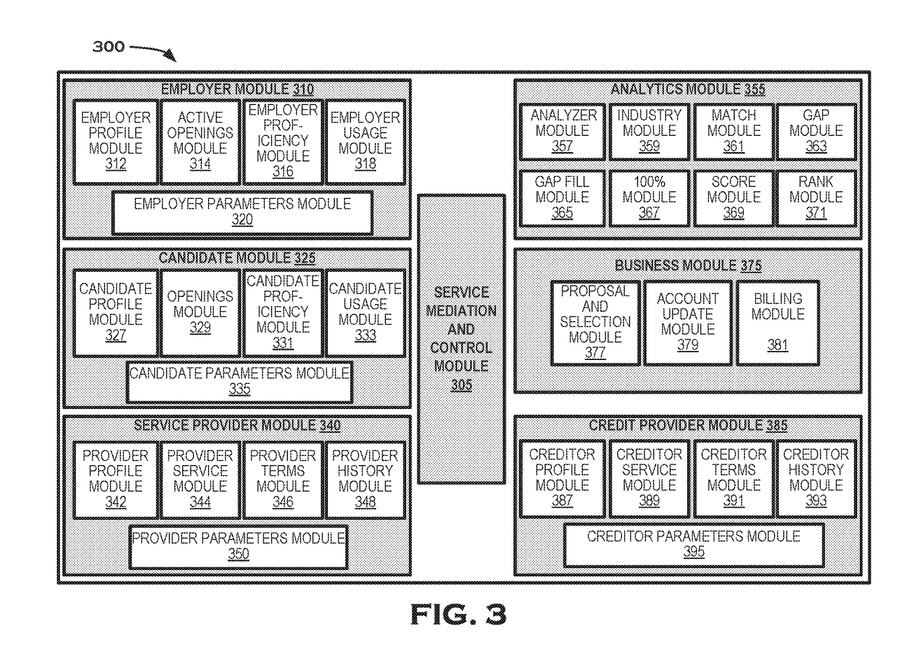

User device 110 may host a copy of all or a portion of a recruiting application to enable user device 110, of a candidate, to communicate with application server 160 and/or to register and/or access services provisioned via application server 160. User device 110 may enable a candidate to provide candidate information (described in greater detail in FIG. 3) relating to credentials of the candidate, a desire type of job, etc. User device 110 may also, or alternatively, access application server 160 to view a job announcement, job offers, etc.

Employer server 120 may include one or more computation or communication devices that gather, process, search, store, and/or provide information in a manner described herein. In one example, employer server 120 may be associated with an employer that desires to post a job announcement and receive information associated with potential candidates that may be qualified for and/or hire for the job. Employer server 120 may access application server 160 to register and provide job information associated with a particular job opening. Employer server 120 may also, or alternatively, enable the employer to provide or modify parameters associated with a job announcement, to identify levels of proficiency desired for selected parameters, and/or to review and/or select candidates to interview, disqualify or to hire. Employer server 120 may host a copy of all or a portion of the recruiting application to enable server 120 to communicate, in a secure manner, with application server 160, as described herein.

Service provider server 130 may include one or more computation or communication devices that gather, process, search, store, and/or provide information in a manner described herein. In one example, service provider server 130 may be associated with a service provider that desires to make available services to a candidate and/or employer with respect to closing a gap in connection with a job announcement. Service provider server 130 may access application server 160 to register and provide service information associated with the service provider, a service offered by the service provider, and/or terms under which such a service can be made available to the candidate and/or employer. Such service information may identify services associated with an educational curricula, specific classes, licenses, or certifications, relocation, real estate, career counseling, etc. that are offered by such provider.

The service information may include various data elements that identify the name of the service provider, curriculum taxonomy (e.g., admission requirements, registration requirements and deadlines, fields of study, matriculation requirements, degrees/certifications offered, etc.), name of a specific class, location of class, dates/times when offered, level of class (e.g., within a curriculum), description of class, syllabus, description of prerequisites for class, description of requisite educational and training credentials (e.g., degree requirements, certifications, etc.), cost per credit hour or class, relocation services and costs thereof, real estate services, career counseling services, etc. Service provider server 130 may host a copy of all or a portion of the recruiting application to enable service provider server 130 to communicate, in a secure manner, with application server 160, as described herein.

Credit provider server 140 may include one or more computation or communication devices that gather, process, search, store, and/or provide information in a manner described herein. In one example, credit provider server 140 may be associated with a credit provider and/or financial institution that desires to make available credit and/or funds, to a candidate and/or employer, to pay for all or a portion of services being provided, by a service provider, to bring the candidate into compliance with a job announcement with respect to closing a gap in connection with such job announcement. Credit provider server 140 may access application server 160 to register and provide credit information, associated with the credit provider, including various data elements that identify the name of the credit provider, a credit service offered by the credit provider, and/or terms under which such credit and/or funds can be made available to the candidate and/or employer. Such credit information may also, or alternatively, identify credit products available, interest rates, repayment terms, fees, forms, etc., that are offered by such credit provider. Credit provider server 140 may host a copy of all or a portion of the recruiting application to enable credit provider server 140 to communicate, in a secure manner, with application server 160, as described herein.

Public server 150 may include one or more computation or communication devices that gather, process, search, store, and/or provide information in a manner described herein. In one example, public server 150 may host a website via which to access to publically available and/or proprietary employment information, employment statistics and/or trends, technology or other fields and hiring rates therein, certain parameters and/or standards used to characterize a type of job (e.g., based on typical duties, job functions, tasks, compensation, educational level, etc.), etc. in connection with a job announcement. Public server 150 may communicate with application server 160 to provide employment and job data, including various data elements associated therewith.

Application server 160 may include one or more computation or communication devices that gather, process, search, store, and/or provide information in a manner described herein. For example, application server 160 may host and/or execute a recruiting application to provide services and/or perform operations associated therewith to user device 110, employer server 120, service provider server 130 and/or credit provider server 140, as described herein. Application server 160 may communicate with user device 110 and/or servers 120-140 to register such devices and/or to provide and/or register a copy of the recruiting application that is compatible with and/or supported by different types of user devices 110 and/or servers 120-140. Application server 160 may authenticate user device 110 and/or any of servers 120-140, to enable user device 110 and/or servers 120-140 to access services provided by application server 160. Application server 160 may enable user device 110 and/or server 120-140 to access application server 160 in a secure manner via an application programming interface (API) and/or a secure protocol (e.g., a tunneling protocol, a hypertext transfer protocol secure (HTTPS), a secure sockets layer (SSL), an Internet Protocol Security (IPsec), and/or some other secure protocol). Application server 160 may also, or alternatively, use such secure communications and/or protocols to automatically obtain (e.g., “pull”) information from employer server 120, service provider server 130, credit provider server 140, public server 150 and/or from websites hosted by such servers, and/or to receive such information that is provided (e.g., “pushed”) to application server 160 from servers 120-150.

Application server 160 may communicate with user device 110 to obtain candidate information to create a profile for the candidate and/or to match a candidate to a job description. Application server 160 may communicate with employer server 120 to create a profile for an employer and/or to obtain information associated with a job announcement with which to process and create a job announcement that can be accessed and/or reviewed by a candidate. Application server 160 may compare candidate information to job announcement information to determine a matching score that represents a degree of match between such candidate information and the job announcement information. Application server 160 may determine a gap, associated with the candidate, based on that portion of the candidate information that does not match the job announcement information. Application server 160 may identify one or more services (e.g., relocation servers, training services, etc.) to be obtained for or performed by the candidate to reduce or eliminate the gap and may determine a cost and/or time period with which to close the gap. Application server 160 may also, or alternatively, obtain information, from credit provider 140, that identifies available credit or financing services that could be made available and may provide a proposal, to an employer, that identifies the candidate, the matching score, a gap, a time to close the gap, a cost to close the gap, one or more candidate services available to close the gap and/or any credit or financing services available.

Application server 160 may also, or alternatively, obtain information, from employer server 120, business and/or recruiting websites associated with public server 150, and/or other parameters relating to a type of job opening. Such information may include various data elements such as name of employer, job title, job location, job level, description of duties, description of skills and abilities, description of requisite educational and training credentials (e.g., degree requirements, certifications, etc.), salary information, etc.

Application server 160 may process the information to conform to supported data format(s) for storage and/or further processing. Subject to receiving consent, application server 160 may also, or alternatively, monitor usage histories associated with employer server 120, service provider server 130 and/or credit provider server 140 to update the information received and/or provided over time to ensure that any changes and/or updates are captured by application server 160.

Database 165 may include one or more devices that store information received from application server 160. For example, database 165 may store copies of the recruiting application that are supported by and/or compatible with different types of user devices 110 and/or servers 120-150. Database 165 may store one or more profiles associated with a user devices 110, servers 120-150, a candidate, employer, service provider, or credit provider that are registered and/or authorized to access wellness services. Database 165 may also, or alternatively, store candidate information, job information, service information, credit information, or employment information and/or information associated with one or more match scores, gaps, costs to close the gap, time to close the gap, etc. Database 165 may also, or alternatively, store project information, received from application server 160, that describes a proposed project that, if implemented, would close the gap, associated with a candidate, for a particular job announcement.

Network 170 may include one or more wired and/or wireless networks. For example, network 170 may include a cellular network, a public land mobile network (PLMN), a second generation (2G) network, a third generation (3G) network, a fourth generation (4G) network, a fifth generation (5G) network, and/or another network. Additionally, or alternatively, network 170 may include a wide area network (WAN), a metropolitan area network (MAN), a telephone network (e.g., the Public Switched Telephone Network (PSTN)), an ad hoc network, an intranet, the Internet, a fiber optic-based network (e.g., FiOS), and/or a combination of these or other types of networks.

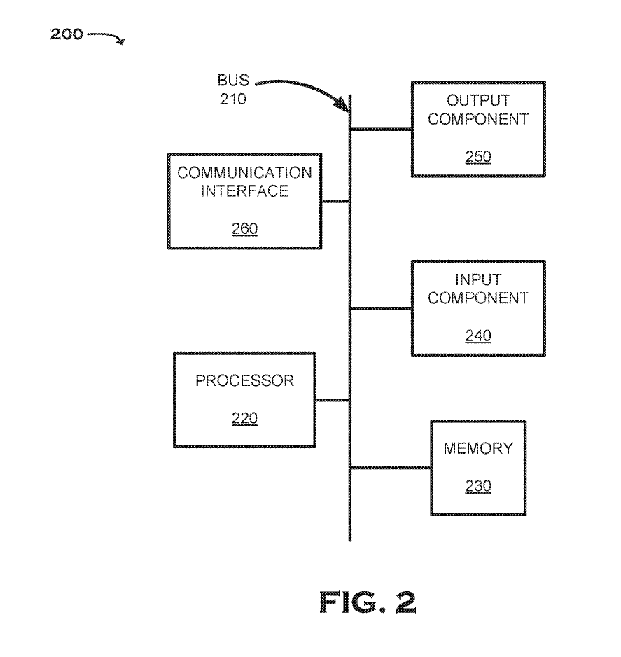

FIG. 2 is a diagram of example components of a device 200 that may correspond to user device 110, employer server 120, service provider server 130, credit provider server 140, public server 150, and/or application server 160. Additionally, or alternatively, each of user device 110, employer server 120, service provider server 130, credit provider server 140, public server 150, and/or application server 160 may include one or more devices 200. Device 200 may include a bus 210, a processor 220, a memory 230, an input component 240, an output component 250, and a communication interface 260. Although FIG. 2 shows example components of device 200, in other implementations, device 200 may include fewer components, additional components, different components, or differently arranged components than depicted in FIG. 2. Additionally, or alternatively, in other implementations, one or more components of device 200 may perform one or more tasks described as being performed by one or more other components of device 200.

Bus 210 may include a path that permits communication among the components of device 200. Processor 220 may include a processor, microprocessor, or processing logic that may interpret and execute instructions. Memory 230 may include any type of dynamic storage device that may store information and instructions for execution by processor 220, and/or any type of non-volatile storage device that may store information for use by processor 220.

Input component 240 may include a mechanism that permits an operator to input information to device 200, such as a keyboard, a keypad, a button, a switch, etc. Output component 250 may include a mechanism that outputs information to the operator, such as a display, a speaker, one or more light emitting diodes (LEDs), etc. Communication interface 260 may include any transceiver-like mechanism that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 260 may include mechanisms for communicating with another device or system via a network, such as network 170.

As will be described in detail below, device 200 may perform operations relating to provisioning a mediated service in connection with an employer, candidate, service provider, credit provider with respect to a job announcement. Device 200 may perform these operations in response to processor 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

FIG. 3 is a diagram of an example framework 300 that may be associated with a recruiting application being hosted and/or executed on application server 160. Additionally, or alternatively, the application may be hosted and/or executed on user device 110 and/or any of servers 120-140. Framework 300 may include logic in the form of software, hardware (e.g., electronic, optical, etc.) or a combination of software and hardware that, when executed, enables application server 160 to perform the functions, activities, or tasks described herein. As shown in FIG. 3, framework 300 may include a service mediation and control module 305 (hereafter, “control module 305”), and employer module 310, a candidate module 325, a service provider module 340, an analytics module 355, a business module 375, and a credit provider module 385. Control module 305 may enable and/or control a manner in which application server 160 uses modules 310-385.

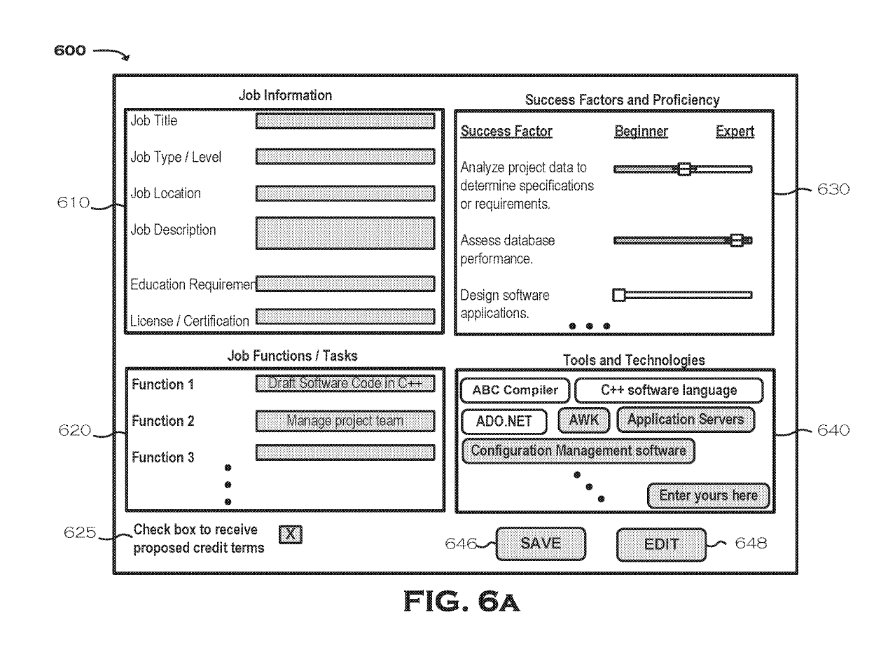

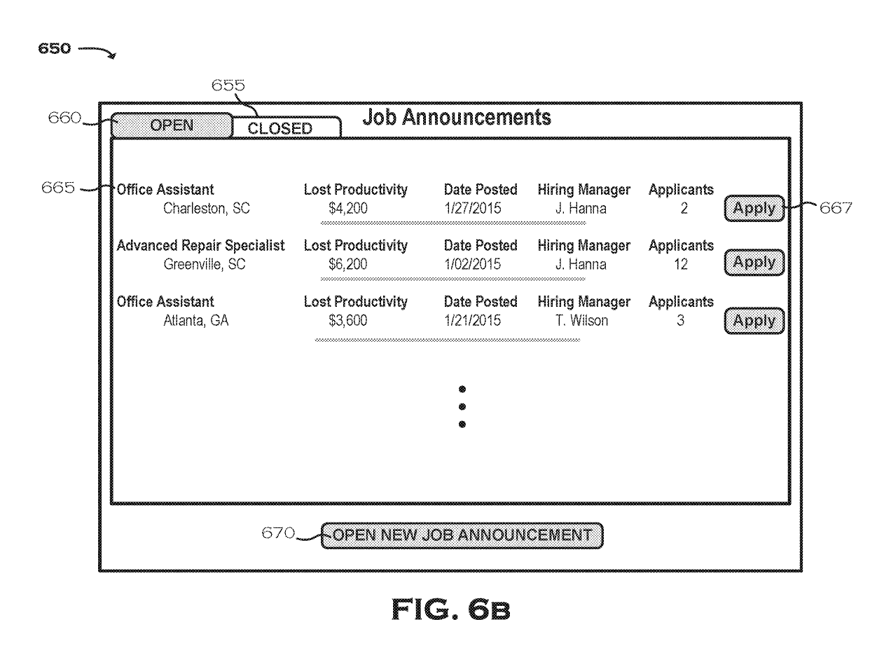

Employer module 310 may control how application server 160 communicates with employer server 120 and/or processes employer information and/or information associated with a job announcement. For example, employer module 310 may include an employer profile module 312 (hereafter “profile module 312”), a job opening module 314, an employer proficiency module 316 (hereafter, “proficiency module 316”), an employer usage module 318 (hereafter, “usage module 318”), and an employer parameters module 320 (hereafter “parameters module 320”). Profile module 312 may enable application server 160 to create and maintain a profile associated with employer server 120 and/or an employer, from which a job announcement has been, or will be, posted via application server 160. Such a profile may include employer information (e.g., name of employer, employer address, employer email address, employer phone number, etc.), information associated with employer server 120 (e.g., a network address, Internet Protocol (IP) address, a media access control (MAC) address, etc.), information identifying a job opening, a status of such job opening (e.g., open, closed, filled, etc.), type of service subscription of employer, etc. Job opening module 314 may enable information associated with a job opening, received from employer server 120, to be processed to create a job announcement. Proficiency module 316 may enable job functions, success factors and/or proficiency ratings, as such terms are described with respect to FIG. 6, to be created and/or received from employer server 120. Usage module 318 may identify which job announcements are associated with employer, candidates provided for each job announcement and/or how frequently employer server 120 accesses application server 160 and/or the services available via application server 160. Parameter module 320 may include information that identifies preferences and/or parameters of employer (e.g., certain preferred success factors, weighting values, disclaimers, etc.) to be used, by application server 120, when creating a job opening associated with employer server 120.

Candidate module 325 may control how application server 160 communicates with user device 110 and/or processes candidate information associated with a candidate and/or user device 110. For example, candidate module 325 may include an candidate profile module 327 (hereafter “profile module 327”), a openings module 329, an candidate proficiency module 331 (hereafter, “proficiency module 331”), an candidate usage module 333 (hereafter, “usage module 333”), and an candidate parameters module 335 (hereafter “parameters module 335”). Candidate module 325 may, in a manner similar to that described with respect to employer module 310, enable application server 160 to create and maintain a profile associated with user device 110 and/or a candidate, from which candidate information, associated with the candidate, is received. Such a profile may include candidate information (e.g., name of candidate, candidate address, email address, phone number, etc.), information associated with user device 110 (e.g., a network address, an IP address, mobile directory number, an electronic serial number, etc.), information identifying a job announcement to which candidate has applied or been identified by application server 160, a status of a pending application (e.g., pending, rejected, offer, etc.), type of expertise or jobs, etc. Job opening module 314 may identify a job announcement for which candidate has been determined to match based on a match score that is greater than a threshold, and/or for which the candidate as applied. Proficiency module 331 may identify certain candidate-set proficiency ratings with respect to candidate skills, knowledge, abilities, etc., to be used to match the candidate to a job announcement. Parameter module 335 may include information that identifies preferences and/or parameters of candidate (e.g., certain preferred proficiency ratings, preferred job types, preferred locations, preferred employers, etc. to be used, by application server 120, when matching the candidate to a job announcement.

Service provider module 340 may control how application server 160 communicates with service provider server 130 and/or processes service information associated with a service provider and/or service provider server 130. For example, service provider module 340 may include a service provider profile module 342 (hereafter “profile module 342”), a service module 344, a provider terms module 346 (hereafter, “terms module 346”), a provider usage module 348 (hereafter, “usage module 348”), and a provider parameters module 350 (hereafter “parameters module 350”). Profile module 342 may, in a manner similar to that described above with respect to modules 312, and 327, enable application server 160 to create and maintain a profile associated with service provider server 130 and/or a service provider, from which service information, associated with the service provider, is received. Such a profile may include service provider information (e.g., name of service provider, service provider address, email address, phone number, etc.), information associated with service provider server 130 (e.g., a network address, an IP address, a MAC address, etc.), etc. Provider service module 344 may enable application server 160 to identify a service that can be provided to a candidate by the service provider in connection with a job announcement. Terms module 346 may identify a time when such a service can be provided, a cost associated with such service, any prerequisites that must be satisfied to qualify for such service, etc. Usage module 348 may identify which services have been previously requested from and/or provided by service provider in connection with one or more job announcements, with which user devices 110 and/or employer server 120 are such services associated, and/or how frequently service provider server 130 accesses application server 160 (all of which may be included in the profile). Parameter module 350 may include information that identifies preferences and/or parameters of service provider (e.g., class reviews, accreditation information, diversity statements, etc.) preferred locations, preferred professors, etc. to be included in a proposal in connection with a job announcement.

Analytics module 355 may control how application server 160 processes job information, candidate information and/or matches candidates to job announcements. Analytics module 355 may include an analyzer module 357, an industry module 359, a match module 361, a gap module 363, a gap fill module 365, a 100% module 367, a score module 369, and/or a rank module 371. For example, application module 160 may use analyzer module 357 to process job information to identify a type of job, job requirements, industry in which job is associated, etc. to create a job announcement. In so doing, application server 160 may use industry module 359 to identify job functions, success factors, and/or other parameters associated with a type of job and/or industry with which a job is associated. Industry module 359 may cause application server 160 to communicate with public server 150 and/or database 165 to obtain information associated with such job functions, success factors, and/or other parameters with which to generate the job announcement. Application server 160 may use control module 305 to determine, from employer proficiency module 318, proficiency ratings that employer desires for selected job functions, success factors, or other parameters. Application server 160 may also, or alternatively, use match module 361 to compare information, associated with a job announcement, to candidate information associated with a candidate to identify which parameters, associated with the job announcement, match parameters associated with the candidate information. Gap module 363 may enable application server 160 to identify, as a gap, a parameter, associated with the candidate, that does not match any parameter associated with the job announcement. Application server 160 may use 100% module 367 to identify a service, from service module 340, that if provided would enable the candidate to be substantially in compliance with the job announcement (e.g., “a 100% complete candidate”) within a period of time (e.g., “time to 100% complete”) and/or based on a particular cost (e.g., “cost to 100% complete”). Score module 369 may enable application server 160 to compute one or more scores, associated with the candidate and relative to other candidates, based on the matching parameters, the gaps, proficiency ratings of candidate, desire proficiency ratings of employer, any weighting values associated with each parameter or proficiency, rating, etc. Application server 160 may use ranking module 371 to rank the candidate, relative to the other candidates, based on the one or more scores associated with the candidate and those associated with the other candidates.

Business module 375 may enable application server 160 to create and/or output a proposal, associated with a job announcement, to employer server 120 in connection with one or more candidates selected by employer. Application server 160 may, for example, use proposal and selection module 377 to generate a proposal that identifies the candidate, an assigned score, any gaps associated with the candidate, a service to close the gap to bring the candidate into substantial compliance with the job announcement, a cost to close such gap, and/or a time period to perform the service to close such gap. Proposal and selection module 377 may also, or alternatively, enable application server 160 to include credit information, associated with any available credit for employer and/or employee, in the proposal in a manner that includes the amount of credit, interest rate, repayment terms, closing terms, etc. Such credit information may be obtained, by application server 160 using credit provider module 385. Application server 160 may use account update module 379 to determine a fee for each candidate provided to employer and/or to which employer grants or conducts an interview, makes an offer, etc. Application server 160 may use billing module 381 to create and/or output a bill to employer server 120 and/or user device 110.

Credit provider module 385 may control how application server 160 communicates with credit provider server 140 and/or processes creditor information associated with a credit provider and/or credit provider server 140. For example, credit provider module 385 may include a credit provider profile module 387 (hereafter “profile module 387”), a creditor service module 389, a creditor terms module 391 (hereafter, “terms module 391”), a creditor usage module 395 (hereafter, “usage module 393”), and a creditor parameters module 395 (hereafter “parameters module 395”). Profile module 387 may, in a manner similar to that described above with respect to profile module 342, enable application server 160 to create and maintain a profile associated with credit provider server 140 and/or a credit provider, from which credit information, associated with the credit provider, is received. Such a profile may include credit information (e.g., name of credit provider, credit provider address, email address, phone number, etc.), information associated with credit provider server 140 (e.g., a network address, an IP address, a MAC address, etc.), etc. Credit Service module 389 may enable application server 160 to securely communicate (e.g., via an API, a secure tunneling protocol, etc.) with public server 150 via which a service can be accessed to determine a credit rating of a candidate, employer, etc. Creditor service module 389 may also, or alternatively, enable application server 160 to identify a credit vehicle (e.g., a loan, a line of credit, a cash advance, etc.) and/or financial service (e.g., such as financial advice and/or counseling services) that can be provided to a candidate and/or employer by the credit provider in connection with a job announcement. Terms module 391 may identify a time when such a credit vehicle and/or financial service can be provided, a cost associated with such credit vehicle and/or financial service, any prerequisites that must be met to qualify for such service (e.g., a minimum credit rating, revolving debt, etc.), etc. Usage module 393 may identify which credit services have been requested from and/or provided by credit provider over a period of time in connection with one or more job announcements, with which user devices 110 and/or employer server 120 are associated and/or how frequently credit provider server 140 accesses application server 160. Parameter module 395 may include information that identifies preferences and/or parameters of credit provider (e.g., reviews, names of loan officers, legal disclaimers, diversity statements, etc.), preferred locations, etc. to be included in a proposal in connection with a job announcement and/or candidate.

Although FIG. 3 shows example modules of framework 300, in other implementations, framework 300 may include fewer modules, additional modules, different modules, or differently arranged modules than depicted in FIG. 3. In still other implementations, one or more modules of framework 300 may perform one or more tasks described as being performed by one or more other modules of framework 300.

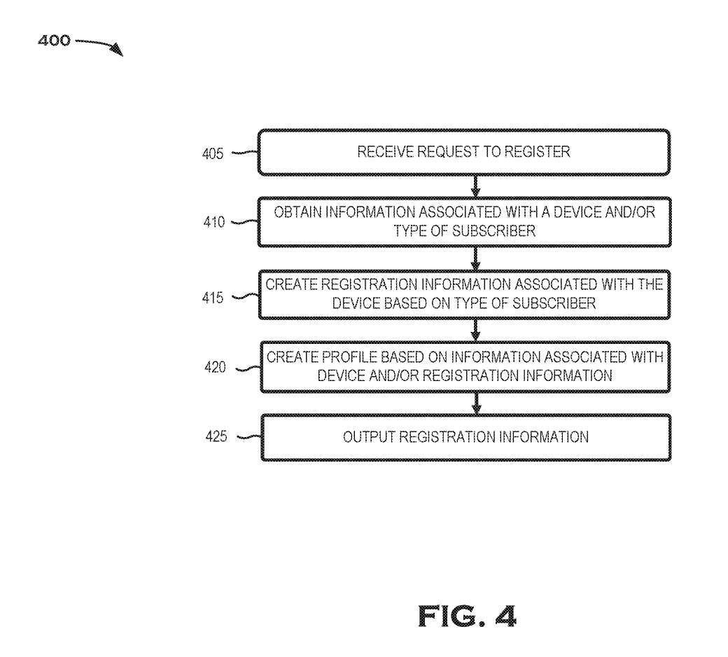

FIG. 4 is a flow chart of an example process 400 that may be used to register one or more devices of FIG. 1 according to an implementation described herein. Process 400 may be performed by application server 160. Additionally, or alternatively, some or all of process 400 may be performed by a device or a collection of devices separate from, or in combination with, application server 160.

As shown in FIG. 4, process 400 may include receiving a request to register (BLOCK 405) and obtaining information associated with a device and information identifying a type of subscriber (BLOCK 410). For example, an employer, associated with employer server 120, may desire to post a job announcement and may cause employer server 120 to transmit a request to register with application server 160. Employer server 120 may also, or alternatively, provide information associated with the employer (e.g., employer name, address, telephone number, etc.) and/or employer server 120 (e.g., an IP address, MAC address, uniform resource locator (URL), an electronic serial number (ESN), etc.), and a type of entity (e.g., an employer desirous of posting a job announcement) to application server 160.

Additionally, or alternatively, in a manner similar to that described in the immediately preceding paragraph, a service provider may desire to make a service available to a candidate and/or an employer and may cause service provider server 130 to transmit a request to register with application server 160. Similarly, service provider server 130 may also, or alternatively, provide information associated with the service provider and/or service provider server 130 including information that identifies a type of entity (e.g., a service provider desirous of providing service information relating to services offered by service provider) to application server 160.

Additionally, or alternatively, a credit provider may desire to provide credit and/or financial resources to a candidate and/or an employer and may cause credit provider server 140 to transmit a request to register with application server 160. Similarly, credit provider server 140 may also, or alternatively, provide information associated with the credit provider and/or credit provider server 140 including information that identifies a type of entity (e.g., a credit provider desirous of providing credit information relating to credit services offered by credit provider) to application server 160.

Additionally, or alternatively, a candidate may desire to find and job and may cause user device 110 to transmit a request to register with application server 160. User device 110 may, for example, provide information associated with the candidate (e.g., candidate name, address, email address, MDN, etc.) and/or user device 110 (e.g., a MDN, an IP address, subscriber identification module uniform resource identifier (SIM URI), etc.) to application server 160.

Application server 160 may receive the request to register and may obtain, from the request, information associated with the device (e.g., depending on which of server 120-140 or user device 110 from which the request was sent) and/or information associated with the subscriber (e.g., employer, service provider, credit provider, or candidate).

As also shown in FIG. 4, process 400 may include creating registration information associated with the device based on the type of subscriber (BLOCK 415), creating a profile based on the information associated with the device and/or the type of subscriber (BLOCK 420), and outputting the registration information to the device (BLOCK 425). For example, application server 160 may, based on the type of subscriber, create registration information associated with the device and/or the subscriber (e.g., user name, password, personal identification number (PIN), a confirmation number, etc.). Additionally, or alternatively, application server 160 may create a profile, associated with the device and/or subscriber, that includes the registration information, the information associated with the device, the information associated with the subscriber, information identifying the type of subscriber, etc.). Application server 160 may store the profile in database 165. Based on creating the profile, application server 160 may transmit a notification, to the device, indicating that the device and/or subscriber is registered. The notification may also, or alternatively, include the registration information that the device may use to access application server 160 in a future session.

Once registered, an employer may use employment server 120 to create a job announcement and/or to find qualified candidates; a candidate may use user device 110 to upload candidate information to enable the candidate to find a job; a service provider may upload service information that can be used by an employer and/or candidate to bring they candidate into compliance with a job announcement; and a credit provider may upload credit information that can be used to fund the expenses associated with bringing the candidate into compliance.

For example, application server 160 may obtain information from service provider server 130 and/or a website hosted thereby in connection with educational curricula and/or specific classes, licenses, or certifications, relocation, real estate, career counseling, etc. that are offered by such provider (“service information”). The service information may include various data elements that identify the name of the service provider, curriculum taxonomy (e.g., admission requirements, registration requirements and deadlines, fields of study, matriculation requirements, degrees/certifications offered, etc.), name of a specific class, location of class, dates/times when offered, level of class (e.g., within a curriculum), description of class, syllabus, description of prerequisites for class, description of requisite educational and training credentials (e.g., degree requirements, certifications, etc.), cost per credit hour or class, relocation services and costs thereof, real estate services, career counseling services, etc. The service information may also, or alternatively, correspond to other service providers such as moving companies, real estate firms, etc. Subject to the service provider consent, application server 160 may also, or alternatively, monitor usage histories and/or update a profile, associated with service provider server 130, over time to ensure that any changes and/or updates in service information are captured by application server 160.

In a manner similar to that described above with respect to service provider server 130, application server 160 may obtain, from credit server 140, credit information that includes various data elements that identify the name of credit provider, credit worthiness requirements, credit limits, credit terms, and other credit-related parameters. Application server 160 may monitor and update usage histories and may create and maintain a profile associated with the credit provider.

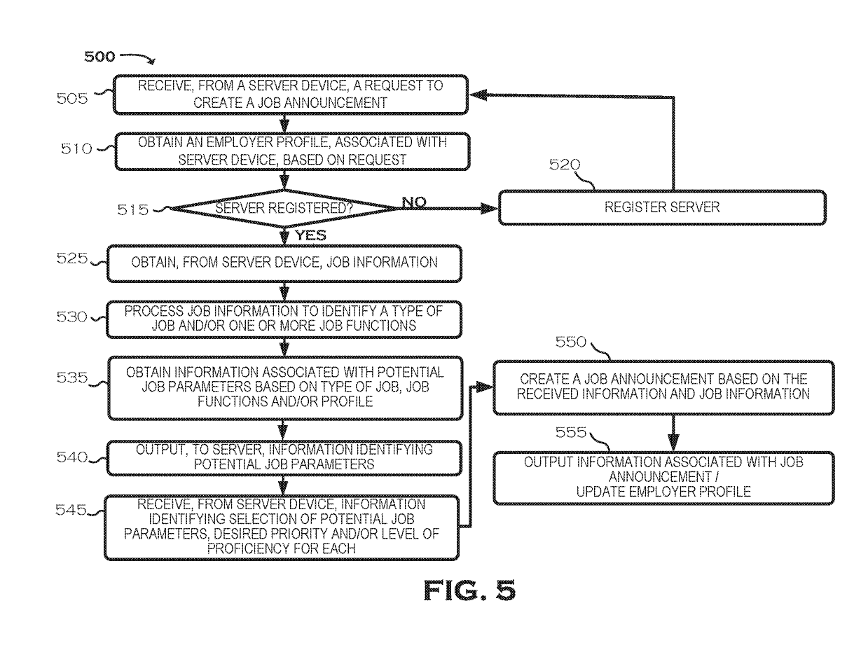

FIG. 5 is a flow chart of an example process 500 that may be used to create a job announcement according to an implementation described herein. Process 500 may be performed by application server 160. Additionally, or alternatively, some or all of process 500 may be performed by a device or a collection of devices separate from, or in combination with, application server 160. FIGS. 6A & 6B are diagrams of example user interfaces 600 and 650, respectively, that may enable a job announcement to be created and/or made available to a candidate. Process 500 of FIG. 5 will be described below with reference to all or a portion of user interfaces 600 and 650 of FIGS. 6A and 6B.

As shown in FIG. 5, process 500 may include receiving, from a server device, a request to create a job announcement (BLOCK 505) and obtaining a profile, associated with the server device, based on receiving the request (BLOCK 510). For example, an employer may desire to create a job announcement and may cause employer server 120 to transmit a request to create a job announcement to application server 160. Application server 160 may receive the request and may obtain, from the request, registration information associated with employer server 120 (e.g., a confirmation number, a user name, password, PIN, information associated with employer server 120, etc.). Application server 160 may determine whether the obtained registration information matches registration information, identified in a profile associated with employer server 120, stored in database 165.

As also shown in FIG. 5, if the server device is not registered (BLOCK 515-NO), then process 500 may include registering the server device (BLOCK 520). For example, in the event that the registration information, obtained from the request, does not match that which is identified in the profile, application server 160 may register and/or re-register employer server 120 in a manner described above with respect to process 400 of FIG. 4.

As further shown in FIG. 5, if the server device is registered (BLOCK 515-YES), then process 500 may include obtaining job information from the server device (BLOCK 525) and processing the job information to identify a type of job and/or one or more job functions (BLOCK 530). For example, in the event that the registration information, obtained from the request, matches that which is identified in the profile, application server 160 may obtain job information from employer server 120. In one example, application server 160 may transmit, to employer server 120, information associated with a user interface (e.g., user interface 600 of FIG. 6A) via which the employer may enter job information.

As illustrated in FIG. 6A, user interface 600 may include a collection of fields and/or buttons including a job information field 610, a job functions field 620, a credit field 625, a success factors and proficiency field 630 and a tools and technologies field 640, a save button 646 and an edit button 648.

Job information field 610 may enable the employer to enter information associated with a job announcement. Such information may include, for example, a job title, a job type and/or level (e.g., software engineering/supervisory, laborer/entry level, executive assistance/senior staff, etc.); a location at which the job is located (e.g., address, city, state, work from home, etc.); and/or a job description that sets forth the type of duties, responsibilities, job functions, organization with which job is associated, etc. Additionally, or alternatively, Job information field 610 may enable the employer to enter educational requirements for the job (e.g., high school graduate, bachelor's degree, master's degree, etc.) and/or information regarding any license or certification requirements (e.g., law license, professional engineer, driver's license, project management certification, etc.).

Job functions/tasks field 620 may enable the employer to enter on or more job functions and/or job tasks associated with the job announcement (e.g., ability to write code in a particular software language, a skill driving a fork lift, an ability to manage a project team, etc.). Additionally, or alternatively, application server 160 may provide, in job functions/task field 620, suggested job functions based on the job information, entered in job information field 610.

Credit field 625, when selected, may enable the employer to request credit terms and conditions that may be provided by a credit provider associated with credit server 140. The credit terms and conditions may identify an amount of credit that may be approved and/or extended to the employer or the candidate to cover the cost to bring the candidate into complete compliance with the job parameters associated with a job announcement.

Application server 160 may provide to employer server 120 all or a portion of user interface 600. For example, to obtain job information and/or one or more job functions, application server 160 may provide only fields 610 and 620 and may hide, render in active, or not provide other fields such as success factors and proficiency field 630 and/or tools and technologies field 640 (each of which will be described below). Additionally, or alternatively, application server 160 may provide, to employer server 120, all or some other portion of user interface 600.

Returning to FIG. 5, the employer may enter the job information and/or job functions into user interface 600 and may select the save button 646 which may cause employer server 120 to transmit the job information and/or job functions to application server 160. Additionally, or alternatively, employer may select edit button 648 to modify any saved job information. Once modified, employer may select save button 646 to transmit the modified job information to application server 160. Application server 160 may receive the job information and/or job functions and may process the information to identify a type of job and/or other job functions and/or success factors.

As yet further shown in FIG. 5, process 500 may include obtaining information associated with potential job parameters based on the identified type of job, job functions and/or profile (BLOCK 535) and outputting, to the server, information identifying potential job parameters (BLOCK 540). For example, application server 160 may, based on the type of job identified by the received job information, obtain potential job parameters associated with the job information. In this example, application server 160 may obtain, from database 165 and/or public server 150 (e.g., associated with a governmental agency or private entity from which employment and/or labor data and/or statics can be obtained), one or more potential job functions associated with the type of job. Additionally, or alternatively, application server 160 may obtain, from database 165 and/or public server 150, information that identifies one or more potential success factors based on the type of job and/or job functions. The success factor may be different than a job function to the extent that such success factor identifies an activity, skill, and/or particular knowledge that, if possessed or performed by the employee, is likely to enable the employee to successfully execute a job function.

Additionally, or alternatively, application server 160 may obtain, from database 165 and/or public server 150, information that identifies one or more tools and/or technologies associated with the type of job, a job function, a success factor, etc. The tools and technologies may, by way of a non-limiting example, correspond to particular software language, operating system, hardware system, etc. for a type of job that corresponds to a software developer, or similar job type. For a warehouse technician job, such tools or technologies may correspond to a type of forklift, inventory system, etc. Application server 160 may transmit, to employer server 120, information that identifies the potential job parameters including, for example, a potential job function, success factor and/or tools and technologies. In one example, application server 160 may transmit, to employer server 120, a user interface (e.g., user interface 600 of FIG. 6A) via which such information is presented for display to be viewed by the employer.

For example, as shown in FIG. 6A, success factors/proficiency field 630 may include one or more success factors (e.g., ability to analyze project data to determine specifications or requirements, assess database performance, design software applications, etc.), identified by application server 160 based on the job information entered into job information field 610 and/or job functions/tasks field 620. Additionally, or alternatively, success factors/proficiency field 630 may enable the employer to identify a level of proficiency for each success factor (e.g., by permitting the employer to move a slider in a first direction (e.g., to the right toward “Expert”) to increase a desired proficiency level or in a second direction (e.g., to the left toward “Beginner”) to decrease the desired proficiency level for a particular success factor and/or job function (not shown in FIG. 6A). Tools and technologies field 640 may identify a list of technologies (e.g., shown as icons or buttons in field 640), tools, applications, etc. based on the job functions, success factors, and/or job type from which employer may select (e.g., using a pointing device, a key board, a touch screen, etc.) as being important to the job (e.g., shown as unshaded icons or buttons in field 640). Additionally, or alternatively, employer may enter a tool and/or technology (e.g., shown as the button labeled “enter yours here” in tools and technologies field 640) that is not identified in the list of technologies.

Although not shown in FIG. 6A, user interface 600 may also, or alternatively, enable the employer, in a manner described above, to designate a level of proficiency for each tool, technology, success factor, job factor, etc. Additionally, or alternatively, user interface 600 may also enable the employer to determine an order of priority for each job function, success factor, tool and/or technology. For example, the employer may change an order of the list of job functions (e.g., highest priority being at or near the top of the list of job functions and/or lowest priority being at or near the bottom of the list job functions, etc.). Similarly, the employer may change an order of priority for each success factor and/or tools and/or technology.

As further shown in FIG. 5, process 500 may include receiving, from the server device, information identifying selection of potential job parameters, desired priority, and/or level of proficiency (BLOCK 545), creating a job announcement based on the received information and the job information (BLOCK 550), and output information associated with the job announcement and update employer profile (BLOCK 555). For example, the employer may select save button 646 to cause employer server 120 to transmit, to application server 160, information identifying selected job parameters, a desired order of priority, and/or a level of proficiency for each job parameter (e.g., job functions, success factor, tool and/or technology, etc.).

Application server 160 may receive the information, identifying the selected job parameters, the desired order of priority, and/or the level of proficiency and may create a job announcement based on such information and/or the job information received from user device 110 in a manner described above (e.g., with respect to BLOCK 525). Application server 160 may output the information associated with the job announcement for display via a website hosted by application server 160 and/or one or more different websites, hosted by one or more public servers 150, associated with job boards, a recruiting site, etc. Additionally, or alternatively, application server 160 may output the information, associated with the job announcement, to employer server 120. Application server 160 may update the employer profile by storing information that indicates that the job announcement has been created. Such information may identify a date on which the announcement was created, a status of the job announcement (e.g., pending, open, closed, filled, etc.), a quantity of candidates that have applied for the job, etc.

The display of the job announcement may correspond to a user interface and/or webpage (e.g., such as that illustrated in user interface 650 of FIG. 6B). For example, as illustrated in FIG. 6B, user interface 650 may include a collection of fields and/or buttons, such as closed job announcements field 655, open job announcements field 660, one or more job announcement fields 665 (hereinafter referred to individually as “job announcement field 665” and collectively as job announcement fields 665″), one or more apply buttons 667 (hereinafter referred to individually as “apply button 667” and collectively as “apply buttons 667”), and an open new job announcement button 670. User interface 650 may be displayed on a display device associated with user device 110, employer server 120, application server 160, and/or public server 150. The number of fields and/or buttons shown in FIGS. 6A and/or 6B, with respect to user interface 600 and/or 650, respectively, is provided for explanatory purposes only. Additionally, or alternatively, user interface 600 of FIG. 6A and/or 650 of FIG. 6B may include additional fields and/or buttons, fewer fields and/or buttons, different fields and/or buttons, or differently arranged fields and/or buttons than are shown in FIGS. 6A and/or 6B.

Closed job announcements field 655 may identify one or more job announcements 665 (described below) that are closed and/or for which candidates are no longer being sought because they have been filled, could not be filled within a period of time, and/or were closed for other reasons by employer server 120 and/or application server 160 (e.g., failure by employer to pay bill, at employer request, etc.). Open job announcements field 660 may include one or more job announcement fields 665 that are open and for which candidates are being sought. Job announcement 665 may include information that identifies the job (e.g., Office Assistant, Advanced Repair Specialist, Office Assistant), at geographic location where job exists (e.g., Charleston, S.C., Atlanta, Ga., etc.), an estimated amount of money lost due to lost productivity (e.g., $4,200, $6,200 etc.) based on a period of time during which the job opening remain open and unfilled, a time at which job opening 665 was posted (e.g., 1/27/15, 1/02/2015, etc.), a representative of employer (e.g., shown as “Hiring Manager, J. Hanna”) and a quantity of applicants that have applied, or been identified, by application server 160, for the job associated with job announcement field 665. User interface 650 may include other job announcement fields 665 associated with employer server 120 and/or other employer servers 120.

Additionally, or alternatively, apply button 667 may correspond to job announcement field 665, which, if selected by a candidate, associated with user device 110, may enable the candidate to apply for a job with which job announcement 665 is associated. Additionally, or alternatively, open new job announcement button 670 may, if selected by an employer, associated with employer server 120, may enable the employer to open a new job announcement 665 associated with another job.

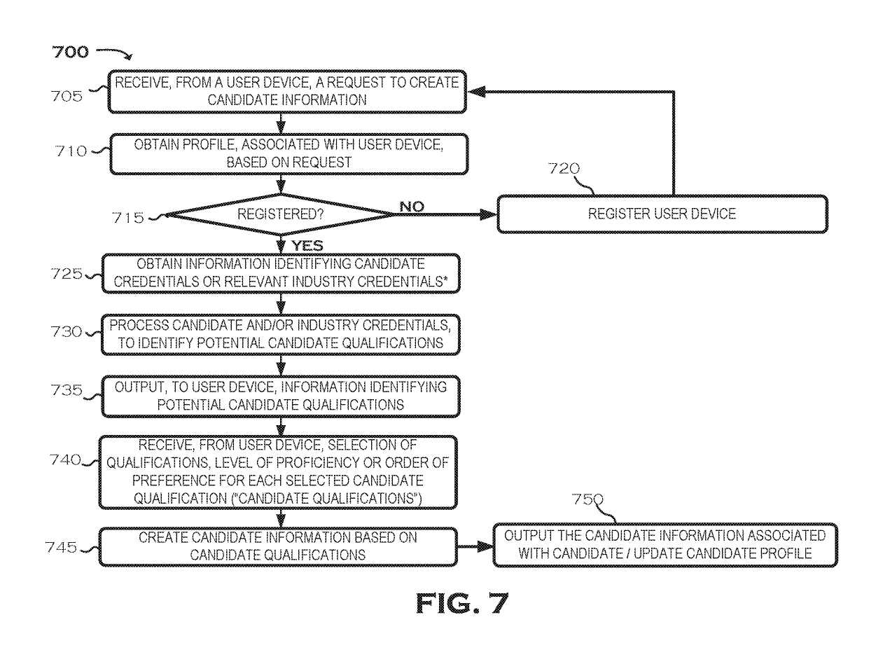

FIG. 7 is a flow chart of an example process 700 that may be used to by a candidate to register and/or to create candidate information according to an implementation described herein. Process 700 may be performed by application server 160. Additionally, or alternatively, some or all of process 700 may be performed by a device or a collection of devices separate from, or in combination with, application server 160.

As shown in FIG. 7, process 700 may include receiving, from a user device, a request to create candidate information (BLOCK 705) and obtaining a profile, associated with the user device, based on receiving the request (BLOCK 710). For example, a candidate may desire to find a job and may cause user device 110 to transmit a request to create candidate information to application server 160. Application server 160 may receive the request and may obtain, from the request, registration information associated with user device 110 (e.g., a confirmation number, a user name, a password, a PIN, a MDN, a SIM URI, an ESN, etc.). Application server 160 may determine whether the obtained registration information matches registration information, identified in a profile, associated with user device 110, stored in database 165.

As also shown in FIG. 7, if the user device is not registered (BLOCK 515-NO), then process 700 may include registering the user device (BLOCK 720). For example, in the event that the registration information, obtained from the request, does not match that which is identified in the profile, application server 160 may register and/or re-register user device 110 in a manner described above with respect to process 400 of FIG. 4.

As further shown in FIG. 7, if the user device is registered (BLOCK 715-YES), then process 700 may include obtaining information identifying candidate credentials from the user device (BLOCK 725) and processing the candidate credentials to identify potential candidate qualifications (BLOCK 730). For example, in the event that the registration information, obtained from the request, matches that which is identified in the profile, application server 160 may obtain information, associated with candidate credentials, from user device 110. Additionally, or alternatively, application server 160 may provide, to user device 110, a user interface via which candidates can post resumes, personal information (e.g., address, phone number, confidentiality preferences, etc.) and other credentials. Application server 160 may enable candidates to post information, associated with the candidate, to application server 160 and/or application server 160 may obtain (e.g., pull), from user device 110 or other professional or social networking sites (e.g., hosted by public server 150), such information entered via the user interface displayed on user device 110.

Application server 160 may process the information, associated with the candidate, to conform to data format(s) supported by application server 160 for storage in database 165 and/or further processing. Subject to candidate consent, application server 160 may also, or alternatively, monitor usage histories associated with the user device 110.

Application server 160 may also, or alternatively, process the information, associated with the candidate credentials, to identify candidate (e.g., candidate name, address, MDN, email address, etc.), educational credentials of the candidate (e.g., name of high school, college, graduate school, college degree, etc.), certifications received by the candidate, licenses held by the candidate, names of current and/or previous employers of the candidate, description of candidate work experience, years of experience of the candidate, type of job being sought by the candidate, etc. Application server 160 may, based on the type of job being sought and/or the candidate credentials (e.g., education credentials, certifications received, licenses held, etc.), obtain information associated with standard qualifications from database 165 and/or public server 150 associated with a government agency and/or private entity form which employment and/or labor data and statistics can be accessed. The information, associated with the standard industry qualifications, may identify one or more typical job functions, success factors, and/or tools and technologies based on the type of job in the field in which the candidate has worked or desires to work. Application server 160 may also, or alternatively, create information associated with potential candidate qualifications based on the information associated with candidate credentials and/or the information associated with the standard industry qualifications.

As further shown in FIG. 7, process 700 may include outputting, to the user device, the information associated with the potential candidate qualifications (BLOCK 735) and receiving, from the user device, selection of the candidate qualifications and/or levels of proficiency (BLOCK 740). For example, application server 160 may output, to user device 110, information associated with the potential candidate qualifications. In one example, application server 160 may transmit, to user device 110, information associated with a user interface via which the information associated with the potential candidate qualifications can be displayed on user device 110. The user interface may, for example, identify the information identifying the candidate, a description of the type of job being sought, the educational credentials, a description of the prior employers and/or work experience of the candidate, etc. Additionally, or alternatively, the user interface may identify the job functions that the candidate is performing or capable of performing and/or standard job functions associated with the type of job being sought and/or the candidate credentials. The user interface may also, or alternatively, include a field that permits the candidate to request and/or authorize a credit service to be made available to aid the candidate to become completely compliant with a job announcement.

User device 110 may receive the information associated with the potential candidate qualifications and may present the information, associated with the potential candidate qualifications, for display on user device 110. The candidate may select some or all of the potential candidate qualifications to be included in the candidate information. Additionally, or alternatively, the candidate may identify a level of proficiency (e.g., between a proficiency range from beginner to expert or some other proficiency range) of each selected qualifications and may cause user device 110 to output, to application server 160, information identifying the selected qualifications and/or respective levels of proficiency for each selected qualification. Application server 160 may receive, from user device 110, the information identifying the selected qualifications and/or respective levels of proficiency for each selected qualification.

As yet further shown in FIG. 7, process 700 may include creating candidate information based on the selected qualifications and the levels of proficiency (BLOCK 745) and output the candidate information and update the candidate profile (BLOCK 750). For example, application server 160 may create candidate information based on the information associated with the candidate credentials, the selected qualifications and/or the levels of proficiency. Additionally, or alternatively, application server 160 may output the candidate information to one or more public servers 150 that host websites associated with job boards, recruiting sites, etc. Additionally, or alternatively, application server 160 may output the candidate information to user device 110. Application server 160 may update the candidate profile by associating the candidate information with the candidate profile and/or storing such candidate information in database 165.

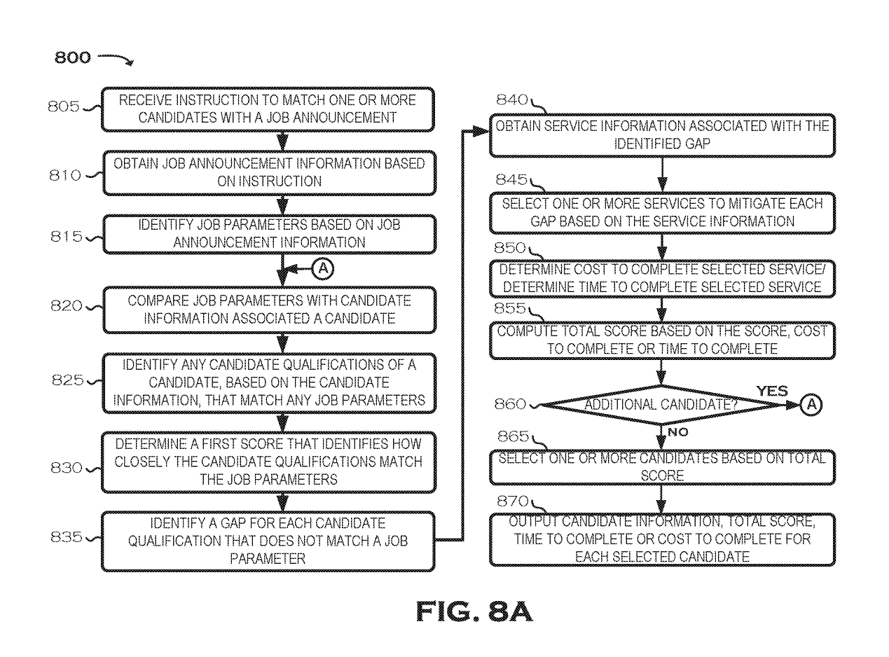

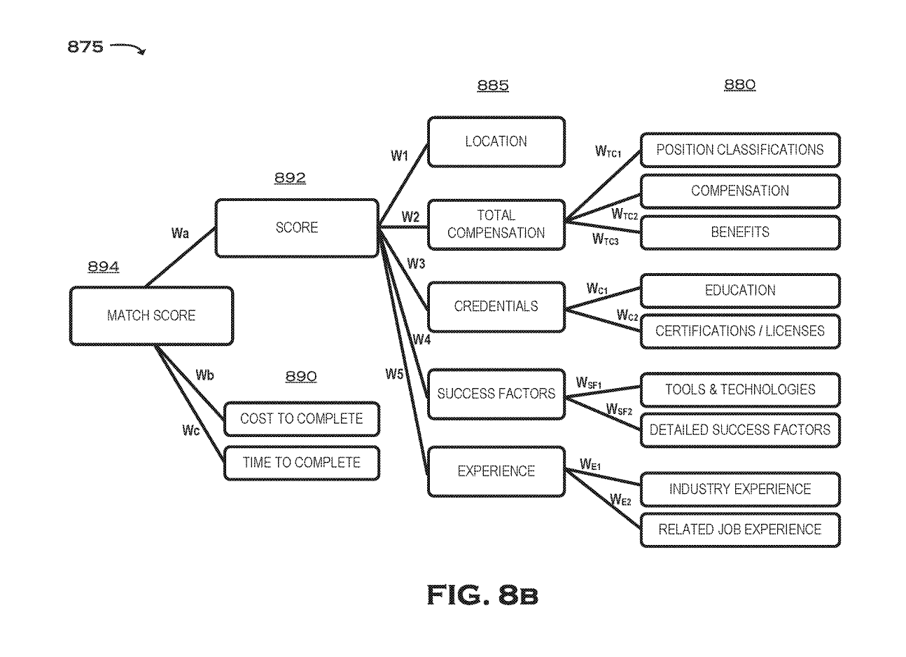

FIG. 8A is a flow chart of an example process 800 to match a candidate with a job announcement according to an implementation described herein. Process 800 may be performed by application server 160 executing a recruiting application. Additionally, or alternatively, some or all of process 800 may be performed by a device or a collection of devices separate from, or in combination with, application server 160. FIG. 8B is a diagram of an example data structure 875 that may be used to match a candidate with a job announcement according to an implementation described herein. Process 800 of FIG. 8A is described below with references to some or all of data structure 875 of FIG. 8B.

As shown in FIG. 8A, process 800 may include receiving an instruction to match one or more candidates with a job announcement (BLOCK 805) and obtaining job announcement information based on the instruction (BLOCK 810). For example, an employer may desire to identify one or more candidates may qualify for a job announcement that was set up in a manner similar to that described with respect to FIG. 5 and may cause employer server 120 to transmit an instruction, to application server 160, to identify potential candidates. Application server 160 may receive the instruction and may obtain, from database 165, job announcement information associated with the job announcement identified by the instruction. Additionally, or alternatively, application server 160 may automatically use the job announcement information that is output as a result of process 500 of FIG. 5 to identify potential candidates.

As also shown in FIG. 8A, process 800 may include identifying job parameters based on the job announcement information (BLOCK 815) and comparing each job parameter to candidate information associated with one or more candidates (BLOCK 820). For example, application server 160 (e.g., using analytics module 355 and/or analyzer module 357 of FIG. 3) may analyze the job announcement information to identify job parameters from the job announcement information. The job parameters may include one or more job functions, one or more success factors, one or more tools and/or technologies and/or a desired level of proficiency for all or a portion of the job parameters.

Additionally, or alternatively, application server 160 may access selected candidate information associated with one or more user devices 110 with which one or more candidates are associated. The selected candidate information may identify candidates that have credentials and/or are seeking a type of job that corresponds to the job announcement. Application server 160 (e.g., using match module 355 and/or match module 361 of FIG. 3) may compare the job parameters to candidate qualifications identify be the candidate information to identify which candidate information most closely matches the job parameters. For example, application server 160 may compare job parameters (e.g., an experience level, ability to perform a job function, ability to perform a success factor, a minimum level of education, requirement to hold a certain license or certification, a salary range, a geographical preference, etc.) to each candidate qualification (e.g., years of experience, type of experience, ability to perform a job function, experience performing a success factor, education credentials, licenses or certification held, place of residency, willingness to relocate, desired salary, etc.) that is identified in candidate information associated with a candidate to identify a quantity of occurrences where the candidate qualifications match the job parameters.

As further shown in FIG. 8A, process 800 may include identifying any candidate qualifications of a candidate, based on the candidate information, that match any of the job parameters (BLOCK 825) and determining a first score that identifies a how closely the candidate qualifications match the job parameters (BLOCK 830). For example, application server 160 (e.g., using match module 355 and/or match module 361 of FIG. 3) may, based on the comparison above, determine that a match has occurred when a candidate qualification matches or satisfies a job parameters. A match may be determined to occur when, for example, a location of the candidate is within a particular first radius (e.g., 5 miles, 10 miles, 100 miles, etc.) of the location identified by a job parameter; when a time at which the candidate is available to begin working is within a first period of time to fill the position (e.g., immediately, one week, two weeks, four weeks, etc.) identified by a job parameter; when the candidate has earned a degree (e.g., master's degree, PhD. degree, etc.) that satisfies a first degree requirement identified by a job parameter; when the candidate possesses a certain skill that matches a first skill requirement (e.g., certification to drive a forklift, etc.) identified by a job parameter; when the candidate has experience over a period of time that is greater than a first experience period identified by a job parameter; etc. Additionally, or alternatively, a match may be determined to occur when the candidate information indicates that the candidate claims a first level of proficiency to perform a skill, job function, or success factor and/or to use a tool and/or a technology, identified by the job parameters, that is within a range of proficiency levels identified by a job parameter.

Application server 160 (e.g., using match module 355 and/or score module 369 of FIG. 3) may assign a first score to the candidate based on a quantity of times that a full or partial match is determined to have occurred and/or one or more match values associated with match occurrence. A first match value (e.g., A=1 or some other first match value) may be assigned when a qualification matches or satisfies a job requirement. As second, different match value (e.g., A<1 or some other second match value) may be assigned when a qualification partially matches or satisfies the job requirement. By way of example, a candidate qualification may partially satisfy a job parameter when, for example, the location of the candidate is not within the first radius but is within a second radius (e.g., 150 miles, 250 miles, etc.) of the location identified by a job parameter; when a time at which the candidate is available to begin working is not within the first period of time but is within a second period of time to fill the position (e.g., five weeks, eight weeks, twelve weeks, etc.) identified by a job parameter; when the candidate has not earned a degree that satisfies a first degree requirement but does satisfy a second degree requirement (e.g., bachelor's degree, master's degree, etc.) identified by a job parameter; when the candidate possesses a certain skill that does not satisfy a first skill requirement but satisfies a second skill requirement (e.g., certification to operate a backhoe, etc.) identified by a job parameter; when the candidate has experience over a period of time that is not greater than the first experience period but is greater than a second, lesser experience period identified by a job parameter; etc. Additionally, or alternatively, a partial match may be determined to occur when the candidate information indicates that the candidate claims a first level of proficiency that is not within the range of proficiency levels but is at a second level that is within a certain amount of the second level of proficiency (e.g., within 5%, 10%, 20%, etc.) identified by a job parameter. Application server 160 may assign one or more scores to each candidate based on match values assigned to one or more job parameters and/or data elements associated with a data structure, stored in database 165, such as that shown in data structure 875 of FIG. 8B.

As shown in FIG. 8B, data structure 875 may include a collection of data elements 880, job parameter elements 885, gap parameter elements 890, a score element 892, and a match score element 894. Data structure 875 may be stored in database 165. The number of data elements and/or scores shown in FIGS. 8B, with respect to data structure 875 is provided for explanatory purposes only. Additionally, or alternatively, data structure 875 may include additional data elements and/or scores, fewer data elements and/or scores, different data elements and/or scores, or differently arranged data elements and/or scores than are shown in FIG. 8B.

Data element 880 may store information that identifies a position classification (e.g., exempt, non-exempt, full time, part time, etc.) associated with a job to which the job announcement is associated; a level of compensation (e.g., hourly rate, salary, incentive payments, etc.) to be paid to a particular candidate selected for the job, any benefits to be provided to the particular candidate (e.g., health insurance, life insurance, bonuses, retirement plans, etc.); level of education required for the job (e.g., high school diploma or equivalent, associate's degree, bachelor's degree, master's degree, PhD. degree, etc.); any certification and/or licenses to be held by the particular candidate; any tools (e.g., hand tools, electronic tools, etc.) and/or technology (e.g., computer, specialized equipment, etc.) to be used by the particular candidate; detailed success factors to be performed by the particular candidate in order to successfully perform a job function; any experience possessed by the candidate that in the same industry with which the job is associated; and any experience possessed by the candidate that is outside the relevant industry, but is relevant or transferrable to the job. Each data element 880 may be associated with a job parameter element based on a first weighting factor (e.g., W1) to be described in greater detail below).

Job parameter elements 885 may store information that identifies a location of the job and/or a desired distance within proximity of the location (e.g., 25 miles, 50 miles, etc.). Total compensation data element 885 may store information associated with position classifications, compensation and/or benefits data elements 880. In one example, total compensation parameter element 885 may be a weighted combination of position classifications, compensation and/or benefits data elements 880 (e.g., based on first weighting values W_{TC1}, W_{TC2}, W_{TC3}, etc., where W_{TC1}+W_{TC2}+W_{TC3}=1) that can be specified by an employer when setting up a job announcement and/or application server 160 based on default first weighting factors. Credentials parameter element 885 may store information associated with a level of education of the particular candidate and/or any certifications and/or license held by the particular candidate, such as that associated with education and/or certification/license data elements 880. Similarly, credentials parameter element 885 may be based on a weighted combination of education data element 880 and/or certifications/licenses data element 885 (e.g., based on first weighting values W_{C1} and W_{C2}, where W_{C1}+W_{C2}=1). Success factor parameter element 885 may store information associated with any tools and/or technologies that the particular candidate is likely to use to perform the job and/or any detailed success factors, associated with a job function, such as that information stored in tools & technology and/or detailed success factors data elements 880. Similarly, success factors parameter element 885 may be based on a weighted combination of tools & technologies data element 880 and/or detailed success factors data element 885 (e.g., based on first weighting values W_{SF1} and W_{SF2}, where W_{SF1}+W_{SF2}=1). Experience data element 885 may store information associated with relevant experience that would be associated with the job including, for example, information stored in industry experience and/or relevant experience data elements 880. Similarly, experience parameter element 885 may be based on a weighted combination of industry experience data element 880 and/or related job experience data element 880 (e.g., based on first weighting values W_{E1} and W_{E2}, where W_{E1}+W_{E2}=1).

Application server 160 may compute a first score 892 based on a combination of job parameter elements 885 and/or a weighted combination of job parameter elements 885 based on job parameter weighting values (e.g., W1, W2, W3, etc.) associated with job parameter elements 885 in the manner described below.

Gap parameter elements 890 may identify any data element 880 and/or job parameter element 885 for which the particular candidate does not comply. Gap parameter element 890 may, for example, include a time to complete data element 890 that identifies a time period for the particular candidate to receive and/or perform a service (e.g., take a class, obtain a license, relocate, etc.) to enable the particular candidate comply each of job parameters elements 885 and/or data elements 880. Gap parameter element 890 may also, or alternatively, identify a cost to complete data element 890 that identifies a cost associated with the service (e.g., a fee for the class, to obtain the license, to relocate, etc.) to enable the particular candidate comply each of job parameters elements 885 and/or data elements 880. Each of the gap parameter data elements 890 may be used to modify first score 892 (e.g., either by increasing or decreasing first score 892) to create a matched score 894 that enables the particular candidate to be evaluated, selected, and/or rejected relative to other candidates with other matched scores 894.

By way of a non-limiting example, the first score 892 may be based on a sum of match values of each job parameters 885 (e.g., first score=A1+A2+A3, etc., where A1, A2, A3, etc. represent the match value of each job parameter identified in the job announcement). Each match value may correspond to a whole number in the event of a complete match and/or a fractional number based on a partial or fractional match. For example, a 100% match (e.g., A=1) may be found if a candidate is within fifty miles of the job location; a 50% match (e.g., A=0.5) if the candidate is not within fifty miles and is within one hundred miles of the job location; and a 0% match (e.g., A=0 or sometimes referred to as a “gap”) if the candidate is not within one hundred miles of the job location. Additionally, or alternatively, the first score may be based on a weighted sum of the match values, such that certain match values may contribute more to the first score than other match values. For example, application server 160 may determine, from the job announcement information, a desired priority or weighting that the employer has specified (e.g., when the job announcement was created) for each of the job parameters and/or data elements identified in the job announcement. Application server 160 may generate one or more weighting values with which to weight the matches. In this example, each job parameter element 885 may be represented by a match value (e.g., A1, A2, A3, etc.) and a respective weighting value (e.g., W1, W2, W3, etc., where 0≦W≦1 and where the sum of W1, W2, W3, etc.=1) may be associated with all or a portion of the match values, such that a first weighted score computed using the weighting values (e.g., first weighted score (S1)=A1*W1+A2*W2+A3*W3, etc.). The first weighted score may be represented as S_{1,0,0,} where the subscript “1” represents the first weighted score (e.g., score 892 of FIG. 8B) and the subscript “0,0” indicate that no adjustment to the first weighted score has been made based on a cost or time to bring the candidate into full compliance with the job announcement. In this example, a job parameter that the employer deems to be most important (e.g., A1) may have a greater contribution to the score than a different job factor (e.g., A2) that the employer deems to be less important (e.g., W1>W2).

As yet further shown in FIG. 8A, process 800 may include identifying a gap for each candidate qualification that does not match any job parameter (block 835) and obtaining service information based on the identified gap (BLOCK 840). For example, application server 160 may determine that a candidate qualification does not match (sometimes referred to herein as a “mismatch”) any of the job parameters associated with the job announcement information. Application server 160 (e.g., using match module 355 and/or gap module 363 of FIG. 3) may, based on such a determination, identify a gap associated with the candidate. By way of example, a mismatch may include a geographic mismatch between candidate location and the location identify by a job parameter; a mismatch between candidate education level and the minimum education level required by a job parameter; a mismatch in certifications held by candidate and that required by a job parameter; a mismatch in candidate proficiency and that required by a job parameter; etc.

Application server 160 (e.g., using match module 355 and/or gap fill module 365 of FIG. 3) may use the information associated with a gap and/or mismatch (e.g., a geographical mismatch, a certification mismatch, a skill mismatch, an educational mismatch, a job function mismatch, a success factor mismatch, proficiency mismatch, etc.) to identify a type of service that may be used to correct the mismatch to close (i.e., eliminate) the gap. For example, application server 160 may obtain, from database 165, service information associated with an identified gap. In this non-limiting example, application server 160 may identify service information that could be used to close the gap based on the type of mismatch (e.g., relocation services to close a geographic mismatch; certification training services to close a certification mismatch; skills training to close a skills or proficiency mismatch, etc.). Application server 160 may also, or alternatively, identify service providers that can provide the service at a location in proximity to the candidate and/or the location of the employer or the location of the job.

As also shown in FIG. 8A, process 800 may include selecting a service to close the gap based on the service information (block 845) and determining a cost to complete the service and/or determine a time period to complete the service (BLOCK 850). For example, application server 160 (e.g., using match module 355 and/or 100% module 367 of FIG. 3) may select one or more services and/or services providers, based on the service information, that if provided, performed, or otherwise made available to the candidate would effectively close the gap. Application server 160 may use the service information, associated with the selected service and/or service provider, to identify a time period during which the selected service can be provided to the candidate (e.g., time to complete gap parameter 890 of FIG. 8B). Additionally, or alternatively, application server 160 may use the service information to identify any fees and/or costs associated with selected service (e.g., cost to complete gap parameter 890 of FIG. 8B). Application server 160 may identify the time period and/or any fees or costs for each service that is selected to close one or more gaps of a candidate.

Application server 160 (e.g., using match module 355 and/or 100% module 367 of FIG. 3) may also, or alternatively, determine a total time to complete all of the selected service(s) in order to close the gap by bringing the candidate qualifications into complete (e.g., 100%) compliance with all job parameters. Application server 160 may also, or alternatively, determine a total cost of any and all fees associated with the selected service(s) in order to close the gap by bringing the candidate qualifications into complete (e.g., 100%) compliance with all job parameters.

As further shown in FIG. 8A, process 800 may include determining a total score based on the first score, the cost to complete the selected service, and the time to complete the selected service (block 855). For example, application server 160 (e.g., using match module 355 and/or score module 369 of FIG. 3) may assign a second score (e.g., S2), to a candidate, based on a cost to complete value (e.g., Acost) associated with the cost of the selected service(s) (e.g., S2=Si+Acost). When the cost to complete is less than a first cost threshold, then application server 160 may cause the second score 894 (FIG. 8B) to be: greater than the first score 892 (FIG. 8B) (e.g., S2>S1, or S_{1,1,0}>S_{1,0,0})) when the cost to complete is less than a first cost threshold (e.g., Acost<first cost threshold); approximately equal to the first score when the cost to complete is not less than the first cost threshold and is less than a second cost threshold (e.g., S2≈S1, or S_{1,1,0}≈S_{1,0,0}) when first cost threshold≦Acost<second cost threshold, the second cost threshold being greater than the first cost threshold); and less than the first score (e.g., S2<S1, or S_{1,1,0}<S_{1,0,0}) when the cost to complete is not less than the first cost threshold (e.g., Acost>first cost threshold). In the latter example (e.g., when S2<S1, or S_{1,1,0}<S_{1,0,0}), the cost to complete may be a negative number when the cost to complete is greater than the second cost threshold (e.g., Acost>second cost threshold).

Additionally, or alternatively, application server 160 (e.g., using match module 355 and/or score module 369 of FIG. 3) may assign a second score 894 (FIG. 8B) to a candidate, based on the first score 892 (FIG. 8B) and a time to complete value (e.g., Atime) associated with the time to perform or receive of the selected service(s) (e.g., S2=S1+Atime). When the time to complete is less than a first time threshold, then application server 160 may cause the second score to be: greater than the first score (e.g., S2>S1, or S_{1,0,1}>S_{1,0,0})) when the time to complete is less than a first time threshold (e.g., Atime<first time threshold); approximately equal to the first score when the time to complete is not less than the first time threshold and less than a second time threshold (e.g., S2>S1, or S_{1,0,1}>S_{1,0,0}) when first time threshold<Atime<second time threshold, the second time threshold being greater than the first time threshold); and less than the first score (e.g., S2<S1, or S_{1,0,1}<S_{1,0,0}) when the time to complete is not less than the first time threshold (e.g., Atime>first time threshold). In the latter example (e.g., when S2<S1, or S_{1,0,1}<S_{1,0,0}), the time to complete may be a negative number when the time to complete is greater than the second time threshold (e.g., Atime>second time threshold).

Additionally, or alternatively, application server 160 may generate the second score 894 (FIG. 8B) based on a combination of the first score 892 (FIG. 8B), values associated with the cost to complete and values associated with the time to complete (e.g., S2=S1+Acost+Atime, or S_{1,1,1}=S_{0,0,0}+Acost+Atime). In a manner similar to that described above, the second score may be greater than, approximately equal to, or less than the first score based on the value associated with the cost to complete and/or the time to complete.

Application server 160 (e.g., using match module 355 and/or score module 369 of FIG. 3) may determine a total score based on the first score or first weighted score (based on the quantity of matches and/or the sum of match values between candidate qualifications and job parameters), the cost to complete (e.g., based on the cost to complete the selected service(s)) and/or the time to complete (e.g., based on the time to complete the selected service(s)). In a non-limiting example, the total score may be a sum of the first score (e.g., S1), the cost to complete (e.g., Acost), and/or the time to complete (e.g., Atime) (e.g., S2=S1+Acost+Atime). Additionally, or alternatively, the total score could be a total weighted score based on other weighting factors (e.g., total weighted score (S2)=Wa*S1+Wb*Acost+Wc*Atime, where Wa, Wb, and Wc are the other weighting values associated with the first score, cost to complete and time to complete, respectively) that can be used to control how much each of the first score, cost to complete, and/or time to complete contribute to the total score or total weighted score.

As yet further shown in FIG. 8A, if there are additional candidates to process (BLOCK 860—YES), then process 800 may include comparing each job parameter to other candidate information associated with another candidate (BLOCK 820). For example, application server 160 may determine whether there is any other candidate information, stored within database 165 and associated with another user device 110, that has not been analyzed relative to the job announcement information. In the event that application server 160 determines that there is other candidate information to be analyzed, then application server 160 may compare the job parameters to other candidate qualifications, identified in the other candidate information, in a manner similar to that described above (e.g., with respect to BLOCK 820).

As still further shown in FIG. 8A, if there are no additional candidates to process (BLOCK 860—NO), then process 800 may include selecting one or more candidates based on the total score (BLOCK 865) and outputting candidate information, total score, time to complete, or cost to complete for each selected candidate (BLOCK 870). For example, in the event that application server 160 determines that there is no other candidate information to be analyzed, then application server 160 may select one or more candidates to which one or more highest total scores (e.g., top 1, 3, 5, 10, etc.) have been assigned and/or with total score that is greater than a total score threshold. Application server 160 may output candidate information for each of the selected candidates and/or analytical information that identifies a respective total score, a time period to become completely compliant with the job parameters, and/or a cost to become completely compliant with the job parameters.

Additionally, or alternatively, application server 160 (e.g., using match module 355 and/or rank module 371 of FIG. 3) may rank the candidates based on the total score and may output candidate information and/or analytical information associated with one or more of the ranked candidates (e.g., ranked first, ranked in top three, top five, etc.).

Employer server 120 may receive the candidate information and/or the analytical information and may select one or more candidates with which to engage (e.g., by scheduling an interview, requesting additional information, extending an offer, etc.).

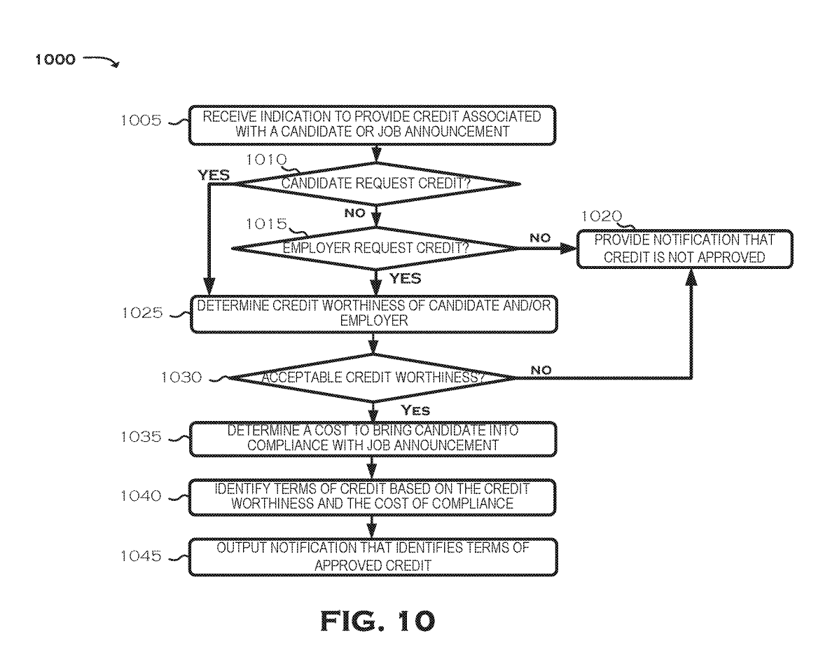

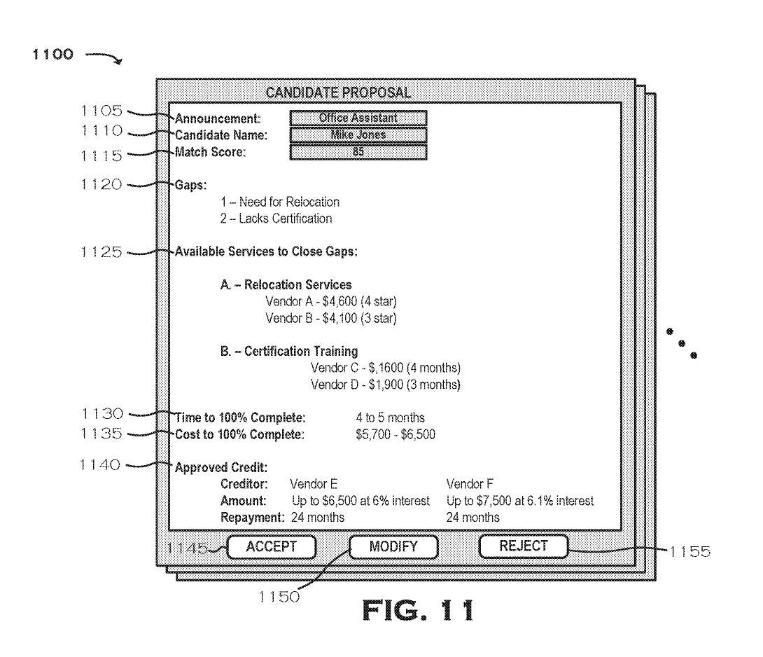

In a non-limiting example, application server 160 may create one or more proposals associated with the one or more selected candidates in connection with a job announcement. A proposal may, for example, identify the selected candidate, the matched score associated with the candidate, any gap associated with the candidate, a service provider and/or service to be made available to close the gap, the cost of the service to become completely compliance, the time to complete the service to become completely compliant, any credit service to be extended to the candidate and/or employer, etc. Such a candidate proposal will be described in greater detail below with respect to FIGS. 10 and 11.

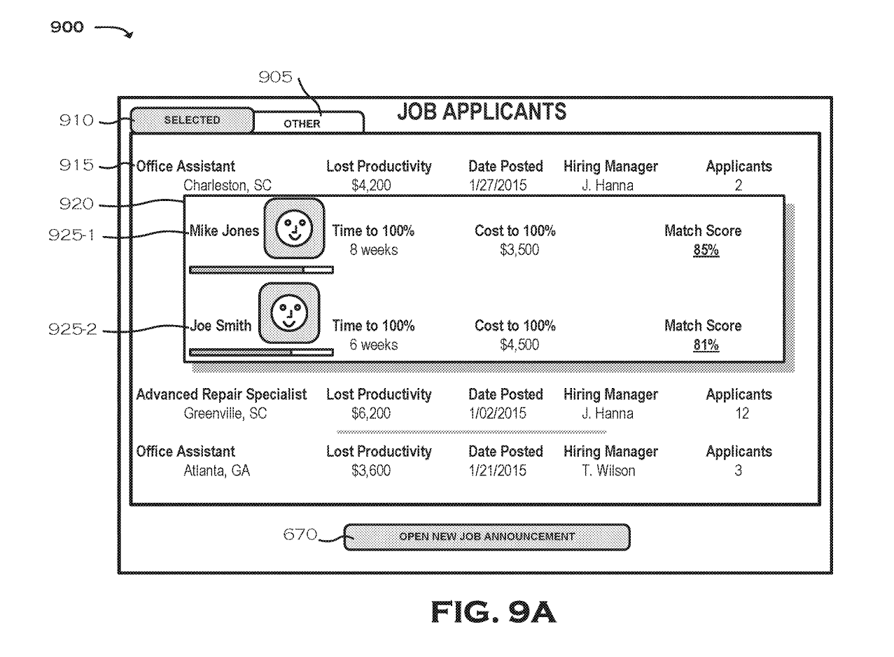

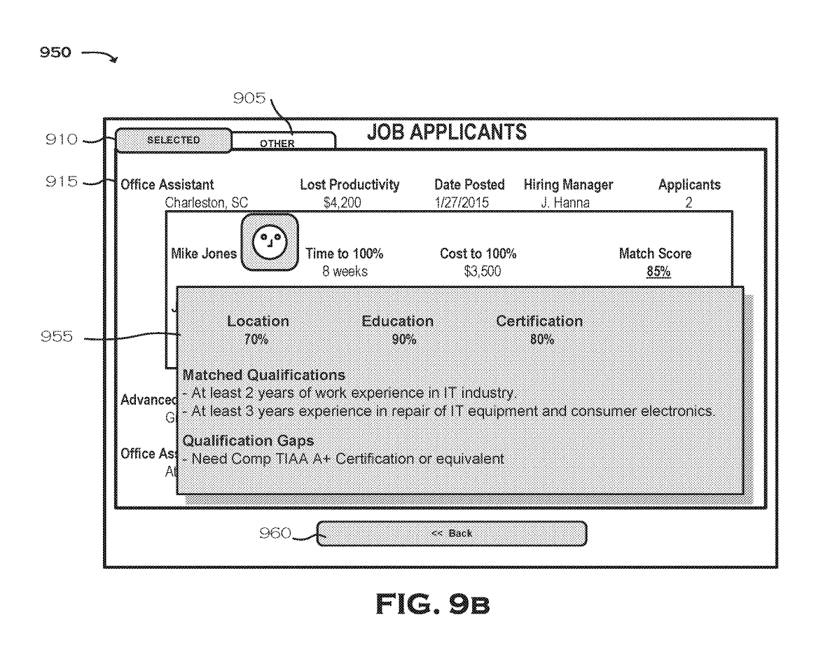

FIGS. 9A and 9B are example user interfaces 900 and 950, respectively, that may identify one or more candidates that are matched to a job announcement. User interfaces 900 and/or 950 may be displayed on a display device associated with employer server 120 and/or application server 160. As illustrated in FIG. 9A, user interface 900 may include a collection of fields and/or buttons including an other candidate field 905, a selected candidate field 910, a job announcement field 915, an applicant field 920, and a pair of candidate fields 925-1 and 925-2.

Other candidates field 905 may correspond to a tab that, when selected by employer (e.g., using a pointing device, a touch screen, a key board, etc.) may cause a window or different user interface to be displayed that identifies candidates that were not selected by application server 160 for one or more job announcements. Such non-selected candidates may correspond to those with total scores that were less than a total score threshold, not within one or more top scores (e.g., not within the top 1, top 3, top 5, etc. total scores) and/or not among the top ranked scores (e.g., not within the first ranked score, top three ranked scores, to five ranked scores, etc.).

Selected candidates field 910 may include job announcement field 915, applicant field 920, and a pair of candidate fields 925-1 and 925-2. Job announcement field 915 may identify a particular job announcement and may correspond to job announcement field 665 of FIG. 6B. Applicant field 920 may identify any candidate selected by application server 160 in a manner similar to that described above (e.g., with respect to BLOCK 865 of FIG. 8A) and/or that have applied to the particular job announcement. Candidate field 925 may identify a selected candidate based on candidate information associated with the candidate and/or analytical information associated with the candidate. For example, candidate field 925 may include information that identifies the selected candidate (e.g., shown as “Mike Jones”, an image or video of Mike Jones in FIG. 9A); a time field that identifies a time period to complete or perform services that enable the candidate to become compliant with all job parameters associated with the particular job announcement (e.g., shown as “time to 100”); a cost field that identifies a cost for services that enable the candidate to become compliant with all job parameters associated with the particular job announcement (e.g., shown as “time to 100”); total score associated with the candidate (e.g., shown as “Match Score”); and/or a graphics object that corresponds to a meter (e.g., shown as the partially shaded bar under the candidate name and image) or some other visual aid to identify how closely a candidate matches the job parameters. In one example, the meter may be based on the total score, the time to 100%, the cost to 100%, or some combination thereof.

As illustrated in FIG. 9B, the employer associated with employer server 120 and/or an operator of application server 160 may select candidate field 925 which may cause an analytical field 955 to be displayed (e.g., in different user interface, pop-up window, etc.) that identifies other analytical information associated with the candidate with respect to the particular job announcement. For example, analytical field 955 may identify a first match value associated with the location of the candidate relative to the job location (e.g., shown as 70% in FIG. 9B); a second match value associated with the education of the candidate relative to that required by the particular job announcement (e.g., shown as 90% in FIG. 9B); and a third match value associated with one or more certifications held the candidate relative to that required by the particular job announcement (e.g., shown as 80% in FIG. 9B). Additionally, or alternatively, analytical field 955 may include a field that identifies particular candidate qualifications that match a job parameter associated with the particular job announcement (e.g., shown as “Matched Qualifications,” “—At least 2 year of work experience . . . ,” and “—At least 3 years of experience . . . ”). Analytical field 955 may also, or alternatively, include a field that identifies particular candidate qualifications that do not match any job parameter associated with the particular job announcement (e.g., shown as “Qualification Gaps,” “—Need Comp TIAA A+ Certification or equivalent.”

User interface 950 may also include a back button 960 that, when selected by employer associated with employer server 120 and/or an operator of application server 160 may cause user interface 900 of FIG. 9A to be displayed.

The number of fields and/or buttons shown in FIGS. 9A and/or 9B, with respect to user interfaces 900 and/or 950, respectively, is provided for explanatory purposes only. Additionally, or alternatively, user interface 900 of FIG. 9A and/or 650 of FIG. 9B may include additional fields and/or buttons, fewer fields and/or buttons, different fields and/or buttons, or differently arranged fields and/or buttons than are shown in FIGS. 9A and/or 9B.

FIG. 10 is a flow chart of an example process 1000 that may enable a credit service to be provisioned to an employer server and/or user device in connection with a job announcement according to an implementation described herein. Process 1000 may be performed by application server 160. Additionally, or alternatively, some or all of process 1000 may be performed by a device or a collection of devices separate from, or in combination with, application server 160. FIG. 11 is a diagram of example user interface 1100 that identifies a proposed plan to enable a candidate to become completely compliant with a job announcement. Process 1000 of FIG. 10 will be described below with reference to all or a portion of user interface 1100 of FIG. 11.

As shown in FIG. 10, process 1000 may include receiving an indication to provide a credit service associated with a job announcement (BLOCK 1005). For example, application server 160 may, in a manner similar to that described above (e.g., with respect to BLOCK 870 of FIG. 8A), output to employer server 120, candidate information, total score, a time to complete and/or a cost to complete for each selected candidate in connection with a job announcement. Application server 160 may also, or alternatively, create a proposal (e.g., as shown in user interface 1100 of FIG. 11 to be described below), associated with the job announcement, based on one or more of the selected candidates. Based on creating the proposal, Application server 160 (e.g., using control module 305 of FIG. 3) may receive an indication to determine whether to identify a credit service within the proposal.

Additionally, or alternatively, application server 160 may determine whether the candidate has requested and/or authorized a credit service when the candidate set up the candidate information (e.g., based on process 700 of FIG. 7) and/or applied to the job announcement by requesting that the candidate information be evaluated, by application server 160, against the job parameters identified by the job announcement information. Additionally, or alternatively, application server 160 may determine whether the employer has requested and/or authorized a credit service when the employer set up the job announcement (e.g., based on process 500 of FIG. 5 by checking the box with respect to credit field 625 of FIG. 6A).

As also shown in FIG. 10, if a candidate has not requested credit (BLOCK 1010—NO) and if the employer has not requested credit (BLOCK 1015—NO), then process 1000 may include outputting a notification that credit is not approved (BLOCK 1020). For example, in the event that application server 160 determines that the candidate did not authorized and/or requested a credit service when creating the candidate information, and that the employer has not authorized and/or requested a credit service when creating the job announcement (based on the job information), application server 160 may output a notification that credit is not approved. Such a notification may also, or alternatively, indicate that a credit service is not to be identified in the proposal associated with a selected candidate in connection with the job announcement.

As further shown in FIG. 10, if the candidate has requested credit (BLOCK 1010—YES) or if the employer has requested credit (BLOCK 1015—YES), then process 1000 may include determining credit worthiness of the candidate or the employer (BLOCK 1025). For example, in the event that application server 160 determines that the candidate has authorized and/or requested a credit service when creating the candidate information, and that the employer has authorized and/or requested a credit service when creating the job announcement (e.g., by checking the box associated with credit field 625 of FIG. 6A), application server 160 may (e.g., using credit provider module 385 and/or creditor service module 389 of FIG. 3) communicate with public server 150 to access a service to obtain a credit rating on the candidate and/or the employer. In this example, application server 160 may provide a portion of the candidate information and/or candidate profile, to public server 150, to obtain information that identifies a measure of credit worthiness (e.g., a credit rating, or some other measurement) of the candidate. Additionally, or alternatively, application server 160 may communicate with user device 110 to obtain such information from the candidate. Application server 160 may also, or alternatively, provide a portion of the employer information and/or employer profile, to public server 150, to obtain information that identifies a measure of credit worthiness (e.g., a credit rating, or some other measurement) of the employer.

As yet further shown in FIG. 10, if the credit worthiness is not acceptable (BLOCK 1030—NO), the process 1000 may include outputting a notification that credit is not approved (BLOCK 1020). For example, application server 160 may determine whether the measure of credit worthiness is greater than a credit threshold. In the event that application server 160 determines that the measure of credit worthiness, of the candidate, is not greater than a first credit threshold, associated with a candidate, and that the measure of credit worthiness, of the employer, is not greater than a second credit threshold, associated with a business, then application server 160 may output a notification that credit is not approved. Such a notification may also, or alternatively, indicate that a credit service is not to be identified in the proposal associated with the candidate in connection with the job announcement. Additionally, or alternatively, the second score, associated with the candidate, may be modified based on the determination that the credit worthiness, of the candidate, is not greater than the first credit threshold. Such modification may include decreasing the second score by a credit value (e.g., Acredit) such that a four-dimensional second score is computed based on the first score (e.g., S1), the cost to complete value (e.g., Acost), the time to complete value (e.g., Atime) (e.g., S2=S1+Acost+Atime−Acredit). Such a decrease in the second score could cause the candidate to drop in rank relative to other candidates that are more credit worthy.

As also shown in FIG. 10, if the credit worthiness is acceptable (BLOCK 1030—YES), then process 1000 may include determining a cost to bring the candidate into compliance with a job announcement (BLOCK 1035) and identifying terms of credit to extend based on the credit worthiness and the cost of compliance (BLOCK 1040). For example, in the event that application server 160 determines that the measure of credit worthiness, of the candidate, is greater than the first credit threshold, or that the measure of credit worthiness, of the employer, is greater than the second credit threshold, then application server 160 may obtain, from the information associated with the proposal, information that identifies a cost to bring the candidate into compliance with the job announcement (e.g., the “cost to 100%”). Additionally, or alternatively, the second score, associated with the candidate, may be modified based on the determination that the credit worthiness, of the candidate, is greater than the first credit threshold. Such modification may include increasing the second score by the credit value (e.g., Acredit) such that the four-dimensional second score is computed based on the first score (e.g., S1), the cost to complete value (e.g., Acost), the time to complete value (e.g., Atime) (e.g., S2=S1+Acost+Atime+Acredit). Such an increase in the second score could cause the candidate to increase in rank relative to other candidates that are less credit worthy.

Based on the cost to 100% and the measure of credit worthiness of the candidate, application server 160 may (e.g., using credit provider module 385 and/or creditor terms module 391 of FIG. 3) may determine an amount of credit to make available to the candidate. The credit may be associated with an interest rate and/or repayment terms (e.g., term of credit, repayment schedule, etc.). Additionally, or alternatively, the extension of credit may be conditioned on the limited purpose of paying a service provider to provide a service to enable the candidate to become completely compliant with the job announcement.

Additionally, or alternatively, based on the cost to 100% and the measure of credit worthiness of the employer, application server 160 may (e.g., using credit provider module 385 and/or creditor terms module 391 of FIG. 3) may determine an amount of credit to make available to the employer. The credit may be associated with an interest rate and/or repayment terms (e.g., term of credit, repayment schedule, etc.). Additionally, or alternatively, the extension of credit may be conditioned on the limited purpose of paying a service provider to provide a service to enable a candidate to become completely compliant with the job announcement. Additionally, or alternatively, the credit terms extended to the employer may cover the cost of compliance for two or more candidates based on a prior credit history of the employer and/or an aggregate cost of compliance for two or more candidates in connection with one or more job announcements.

As further shown in FIG. 10, process 1000 may include outputting a notification that identifies the terms of approved credit (BLOCK 1045). For example, based on the determination of the terms of the credit, application server 160 may output a notification that identifies the terms of the approved credit. Additionally, or alternatively, application server 160 may create a candidate proposal, in a manner similar to that described above (e.g., with respect to BLOCK 870 of FIG. 8A), and may include the information associated with the credit provider and/or information that identifies the terms of the credit to be extended to the candidate and/or the employer.

By way of a non-limiting example, application server 160 may, in a manner similar to that described above with respect to FIG. 8A, create one or more proposals in connection with one or more candidates that have applied or could qualify for a job announcement. Application server 160 may also, or alternatively, create the proposal in a manner that includes information that discloses terms of credit to be extended to a candidate and/or the employer. Application server 160 may output, to employer server 120, a user interface via which a candidate proposal can be displayed such as user interface 1100 illustrated in FIG. 11. User interface 1100 may include a collection of fields and/or buttons including, for example, an job announcement field 1105, a candidate field 1110, a match score field 1115, a gap field 1120, a services field 1125, a time to compliance field 1130, a cost to compliance field 1135, a credit field 1140, and accept button 1145, a modify button 1150, and a reject button 1155. The number of fields and/or buttons shown in FIG. 11, with respect to user interface 1100, is provided for explanatory purposes only. Additionally, or alternatively, user interface 1100 of FIG. 11 may include additional fields and/or buttons, fewer fields and/or buttons, different fields and/or buttons, or differently arranged fields and/or buttons than are shown in FIG. 11.

Job announcement field 1105 may identify information associated with the job announcement (e.g., a job title “Office Assistant,” as shown in FIG. 11, a unique identifier, etc.). Candidate field 1110 may identify a particular candidate (e.g., by a candidate name “Mike Jones,” as shown in FIG. 11, or by a user name, a PIN, a unique identifier, etc.) with which the proposal is associated. Match score field 1115 may identify a total score associated with the particular candidate (e.g., “85” as shown in FIG. 11) based on how closely the particular candidate information matches the job announcement information. Gap field 1120 may identify a candidate qualification that does not match a job parameter identified by the job announcement information, such as, for example, the need for relocation and/or the lack of a certification (e.g., as shown in FIG. 11) required by the announcement.

Services field 1125 may include service information, received from one or more service providers (e.g., shown as “Vendor A”-“Vendor D”) via service provider servers 130, that identifies one or more services for a candidate to close any gap identified in gap field 1120. For example, services field 1125 may identify services (e.g., “Relocation Services” and “Certification Training”); a service provider to provide the services (e.g., Vendors A and B for the relocation services and Vendors C and D for the certification training services); the cost of the services (e.g., $4,600 and $4,100 charged by Vendors A and B, respectively, and $1,600 and $1,900 charged by Vendors C and D, respectively). Services field 1125 may also, or alternatively, identify a rating for the service providers (e.g., “4 Star” for Vendor A and “3 Star” for Vendor B) and/or a time to complete the service (e.g., “4 months” for Vendor C and “3 months” for Vendor D. Application server 160 may treat the service information as bids from different service providers and may automatically select a service provider based on a service that are more favorable (e.g., in terms of cost, time, rating, etc.) than such terms received from another service provider.

Time to compliance field 1130 may identify an estimated time period for the particular candidate to become completely compliant with the job announcement in the event that services were provided and/or accessed by the candidate. Cost to compliance field 1135 may identify a cost associated with the services and/or the cost of credit in the event that such credit is extended to the employer. Credit field 1140 may identify credit information received from one or more credit provider (e.g., shown as “Vendor E” and “Vendor F”). Such credit information may identify one or more creditor providers from which a credit services is being provided (e.g., shown as “Vendor E”); and terms of the credit being offered including an amount of credit (e.g., “$6,500”), an interest rate (e.g., “6%”), a repayment term (e.g., “24 months”) and/or other terms (e.g., restrictions on use of funds, late payment penalties, etc.). Similarly, credit field 1140 may identify other credit providers and/or credit services (e.g., associated with “Vendor F”). Application server 160 may treat the credit information as bids from different credit providers and may automatically select a credit provider with terms of financing that are more favorable than such terms received from another credit provider.

Accept button 1145 may, if selected by the employer, cause application server 160 to execute the proposal by confirming terms of the proposal. The executed proposal may enable employer server 120 to include the proposal in a communication with user device 110 (e.g., to request an interview, to extend an offer, to negotiate employment terms, etc.).

Modify button 1150 may, if selected by the employer, enable the employer to modify one or more terms of the proposal and to provide a modified counter proposal to application server 160 to be forwarded to service provider server 130 and/or credit provider server 140 for consideration and review by a service provider and/or a credit provider, respectively. Reject button 1155 may, if selected by the employer, cause application server 160 to cancel the proposal and/or disqualify the particular candidate from further consideration for the job announcement.

The foregoing description provides illustration and description, but is not intended to be exhaustive or to limit the implementations to the precise form disclosed. Modifications and variations are possible in light of the above teachings or may be acquired from practice of the embodiments.

While series of blocks have been described with regard to FIGS. 4, 5, 7, 8 and 10, the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A server device comprising:
one or more processors executing one or more instructions to:
receive, an instruction to match candidates to a job announcement, the job announcement identifying job parameters associated with a job;
identify, based on the instruction, one or more first qualifications, for each of one or more candidates, that match at least one of the job parameters;
identify, based on the one or more first qualifications, one or more second qualifications, for each of the one or more candidates, that do not match any of the job parameters;
determine, based on the identified one or more second qualifications, a cost, associated with each of the one or more candidates, for a service provider to provide one or more services to enable each of the one or more candidates to obtain the one or more second qualifications;
determine, based on determining the cost, a score for each of the one or more candidates based on the one or more first qualifications, the one or more second qualifications, or the cost to provide the one or more services;
select, based on the score for each of the one or more candidates, a candidate, of the one or more candidates, based on the score for each of the one or more candidates;
obtain, based on the selected candidate, credit information that identifies terms of financing that can be extended, by a credit provider, to cover the cost to provide the one or more services to the selected candidate;
output, based on obtaining the credit information, an indication that identifies at least one of the one or more first qualifications of the selected candidate, the one or more second qualifications of the selected candidate, the score for the selected candidate, the cost to provide the one or more services to the selected candidate, or the credit information.

2. The server device of claim 1, where the one or more processors are further to:
receive, from a different server device associated with an employer that placed the job announcement, a different indication that the employer desires to hire or make contact with the selected candidate; and
provide, to the different server device, contact information associated with the selected candidate.

3. The server device of claim 1, where the one or more processors are further to:
receive, from a different server device associated with an employer that placed the job announcement, a different indication that the employer desires to hire the selected candidate; and
output, by the server device and to a particular server device associated with the service provider, a notification to provide the one or more services to the selected candidate.

4. The server device of claim 3, where the one or more processors are further to:
determine whether the employer desires that the financing be extended to cover the cost to provide the one or more services to the selected candidate; and
output, to a certain server device associated with the credit provider, an instruction to extend the financing to the employer to cover the cost of providing the one or more services to the selected candidate.

5. The server device of claim 1, where, when determining the score for each of the one or more candidates, the one or more processors are further to:
determine a respective time period, for each of the one or more candidates, for the service provider to provide the one or more services to each of the one or more candidates; and
determine the score, for each of the one or more candidates, in a manner that includes the respective time period, for each of the one or more candidates, for the service provider to provide the one or more services to each of the one or more candidates.

6. The server device of claim 1, where the one or more processors are further to:
receive, from a different server device associated with an employer that placed the job announcement, a revised job announcement that identifies a desired level of proficiency, associated with at least one of the job parameters, that is different than that associated with the at least one of the job parameters that is identified in the job announcement; and
identify, based on the instruction, one or more first qualifications, for each of one or more different candidates, that match at least one of the job parameters identified in the revised job announcement.

7. The server device of claim 1, where the one or more services include at least one of:
a first service associated with relocation of the one or more candidates;
a second service, associated with certification training, to enable any of the one or more candidates to obtain a certification that corresponds to the one or more second qualifications;
a third service, associated with training class, to enable any of the one or more candidates to obtain a license that corresponds to the one or more second qualifications; or
a fourth service, associated with a course, to enable any of the one or more candidates to obtain a level of education that corresponds to the one or more second qualifications.

8. The server device of claim 1, where the job parameters identify at least one of:
a job function,
a job location,
a level of education required to perform the job,
a level of compensation to be paid to perform the job,
a success factor that is to be performed to successfully perform the job function,
a tool to be used to perform the job,
a technology to be used to perform the job,
a first desired level of proficiency with respect to performing the job function or the success factor, or
a second desired level of proficiency with respect to using the tool or the technology.

9. The server device of claim 1, where, when obtaining the credit information, the one or more processors are further to:
determine a measure of credit worthiness of the selected candidate; and
output a notification that the financing will not be extended when the measure of credit worthiness is less than a threshold.

10. The serve device of claim 1, where, when obtaining the credit information, the one or more processors are further to:
determining a measure of credit worthiness of the selected candidate; and
outputting a notification that the financing can be extended to cover the cost of the one or more services, for the selected candidate, when the measure of credit worthiness is not less than a threshold.

11. A method performed by a server device executing one or more instructions, the method comprising:
receiving, by the server device, an instruction to match candidates to a job announcement, the job announcement identifying job parameters associated with a job;
identifying, by the server device and based on the instruction, a first candidate, of the candidates, and a second candidate, of the candidates, with one or more first qualifications and one or more second qualifications, respectively, that most closely match the job parameters relative to other qualifications associated with another one or more of the candidates;
identifying, by the server device and based on identifying the first candidate and the second candidate, a third qualification, of the first candidate, that does not match any of the job parameters and a fourth qualification, of the second candidate, that does not match any of the job parameters;
determining, by the server device, a first cost of a first service and a second cost of a second service, the first service enabling the first candidate to obtain the third qualification, and the second service enabling the second candidate to obtain the fourth qualification;
determining, by the server device, a first score for the first candidate and a second score, for the second candidate, the first score being based on the one or more first qualifications, the third qualification and the first cost, and the second score being based on the one or more second qualifications, the fourth qualification and the second cost;
outputting, by the server device and to a different server device associated with an employer that placed the job announcement, a first proposal associated with the first candidate and a second proposal associated with the second candidate,
the first proposal identifying at least one of the first score, the first cost, the one or more first qualifications and the third qualification; and
the second proposal identifying at least one of the second score, the second cost, the one or more second qualifications and the fourth qualification;
receiving, by the server device and from the different server device, selection of the first proposal;
obtaining, by the server device and based on receiving the selection of the first proposal, credit information that identifies terms of financing that could be extended, by a credit provider, to the first candidate or the employer to cover the first cost; and
outputting, by the server device and to the different server device, the credit information.

12. The method of claim 11, further comprising:
receiving, by the server device and from a second server device associated with employer that placed the job announcement, an indication that the employer has selected the proposal from among a plurality of proposals associated with other candidates; and
outputting, by the server device and to a third server device associated with service provider from which the service is to be provided, a notification to make the service available to the candidate.

13. The method of claim 12, further comprising:
outputting, by the server device and to a fourth server device associated with a credit provider from which the financing is to be obtained, a notification to extend the financing to the candidate.

14. The method of claim 11, further comprising:
determining, by the server device, a time period to close the gap that corresponds to the time period for the candidate to receive a service that enables the candidate to obtain the qualification; and
outputting, the proposal in a manner that identifies the time period for the candidate to close the gap.

15. The method of claim 11, where identifying the candidate with the qualifications that most closely match the plurality of job parameters further includes:
comparing the qualifications with the job parameters to identify a portion of the qualifications that match any of the job parameters;
determining a score, associated with the candidate, based on the portion of the qualifications that match the any of the job parameters;
comparing the score with a plurality of other scores associated with other candidates; and
identifying the candidate based on the score relative to the plurality of other scores.

16. A system comprising:
one or more server devices, executing one or more instructions, to:
receive an instruction to identify a candidate that is most closely qualified for a job announcement, the job announcement identifying parameters associated with a job;
compare, based on the instruction, the parameters to qualifications associated with a plurality of candidates;
compute, based on comparing the parameters to the qualifications, a score for each candidate, of the plurality of candidates, the score being based on any matches between the qualifications, of the each candidate, and any of the parameters;
identify, based on computing the score, a qualification gap for the each candidate, the qualification gap being identified when any qualification, of the each candidate, does not match any of the parameters;
obtain, for the each candidate, service information that identifies one or more services that, if provided, can eliminate the qualification gap for the each candidate, the service information identifying a cost for the one or more services;
modify, based on obtaining the service information, the score for the each candidate, based on a respective cost to provide the one or more services, to each candidate, to eliminate the qualification gap;
select a candidate, of the plurality of candidates, based on a modified score, associated with the selected candidate, relative to the modified score for the each candidate; and
output information that identifies the modified score associated with the selected candidate, any matches between the qualifications of the selected candidate and any of the parameters, a qualification gap of the selected candidate and the respective cost to provide the one or more services to eliminate the qualification gap of the selected candidate.

17. The system of claim 16, where the one or more server devices are further to:
extend, to the selected candidate, credit to cover a particular cost for the selected candidate to receive a particular service, of the one or more services, to cause a particular qualification gap, of the selected candidate, to be eliminated.

18. The system of claim 16, where, when computing the modified score for the each candidate, the one or more server devices are further to:
determine a time, for the each candidate, to complete the one or more services to eliminate the qualification gap; and
compute, based on determining the time for the each candidate, the modified score, for the each candidate, in a manner that is includes the time for the each candidate to complete the one or more services.

19. The system of claim 16, where, when outputting the information, the one or more server devices are further to:
create a proposal, associated with the selected candidate, that includes information that identifies at least one of:
the job announcement,
the one or more parameters,
one or more qualifications, of the selected candidate, that matches any of the one or more parameters,
any qualification gaps of the selected candidate,
the first score, the second score, or the third score for the selected candidate,
a service, of the one or more services, that is to be provided to the selected candidate,
a cost of the service,
a time to complete the service, or
any credit service that is to be extended, to the candidate, to cover the cost of the service.

20. The system of claim 19, where the one or more server devices are further to:
receive, from a different server device associated with an employer, an indication that the employer desires to interview or hire the selected candidate; and
output, to the different server device, contact information associated with the selected candidate.
